(19) United States
(12) Patent Application Publication
(10) Pub. No.: US 2024/0397969 A1
(43) Pub. Date: Dec. 5, 2024

(54) A PLANT-BASED PROTEIN CONCENTRATE AND METHOD FOR PREPARING THE SAME

(71) Applicant: VALIO LTD, Helsinki (FI)

(72) Inventors: Mika IMMONEN, Helsinki (FI); Klaus MUURONEN, Helsinki (FI); Päivi MYLLÄRINEN, Helsinki (FI); Niina VALKONEN, Helsinki (FI)

(21) Appl. No.: 18/700,789

(22) PCT Filed: Oct. 27, 2022
(86) PCT No.: PCT/FI2022/050707

§ 371 Date: Apr. 12, 2024

(30) Foreign Application Priority Data
Oct. 29, 2021 (FI) 20216122

(51) Int. Cl. A23J 1/12; A23J 3/14; A23J 3/34; A23L 33/185

(52) U.S. Cl. CPC A23J 1/125; A23J 3/14; A23J 3/346; A23L 33/185

(57) ABSTRACT

The present disclosure relates to the field of food technology, and in particular to a process for concentrating plant-based protein. The disclosure also relates to a plant-based protein concentrate obtainable with the process of as defined in the present disclosure. The present disclosure further relates to food products including said plant-based concentrate and uses thereof.

### FIELD OF THE DISCLOSURE

The present disclosure relates to the field of food technology, and in particular to a process for concentrating plant-based proteins. The disclosure also relates to a plant-based protein concentrate obtainable with the process of as defined in the present disclosure. The present disclosure further relates to food products comprising said plant-based concentrate and uses thereof.

### BACKGROUND OF THE DISCLOSURE

Various plant-based alternatives to dairy-based products have been introduced on the market and there is an increasing demand for such dairy-alternative or dairy-replacement products, such as plant-based products. Raw materials used for producing plant-based products include cereals, nuts, peas, potato, and various seeds. Market prospects for products produced from said plant materials are increasing. An increase in the market of plant-based products is explained for example by health awareness, lactose intolerance or allergy to milk. In addition, ethical choices and environmental effects have increased the demand of plant-based products. Furthermore, increasing number of consumers voluntarily prefer a vegetarian or vegan diet.

There is a constant and increasing need in the food industry for high quality plant protein isolates and concentrates which are suitable for use as an ingredient in the production of various food products. The need is especially for high quality ingredients for producing dairy analogues such as plant-based drinks, yoghurts, snacks, cheeses, and meat analogues.

One challenge for the food processing industry is how to better use side streams resulting from the processes, such as fiber and proteins for human use. As a side stream of the manufacture of flour for example a lot of bran from different source plants, such as wheat and rice are produced in excess. Bran is often used as animal feed although it is a good source of fiber and protein for humans.

Plant protein concentrates and isolates are commonly produced using alkaline extraction or dry fractionation. Proteins from grain material, such as bran, are conventionally extracted with alkaline extraction. Alkaline extraction in highly alkaline pH (pH above 9.0) can cause changes in the protein structure, such as hydrolysis of native proteins, crosslinking, and racemization of amino acids, as well as a decrease in the techno-functional properties of proteins. An advantage of alkaline extraction is that it helps to solubilize the proteins behind the mechanical barriers created by fibers, such as β-glucans, arabinoxylans, and cellulose. However, β-glucan and arabinoxylans increase viscosity, which leads to challenges during the alkaline extraction process, subsequently decreasing the yield of extractable protein. In addition, starch pasting increases viscosity, if heat is required during the extraction process. It is known that plant proteins have limited solubility under neutral or slightly acidic pH, which are the most common pH conditions in food systems.

EP1371734 discloses a process wherein denatured milk protein is deamidated by a protein deamidating enzyme and further treated proteolytically.

The publication by Jiang et al. 2015 relates to improvement of oat protein solubility by enzymatic deamidation with protein-glutaminase (PG). They showed that deamidation by protein-glutaminase did not significantly alter the structure of oat proteins.

The publication by Yong et al. 2017 relates to use of alkaline extraction method to obtain oat protein isolate from oat grains.

The quality of plant protein concentrates and isolates produced by the known methods, such as the alkaline extraction is not optimal for producing dairy analogues such as plant-based drinks, yoghurts, snacks, cheeses and meat analogues.

Despite the advances in the technology to produce plant-based food products there remains a need of improved methods and products.

### BRIEF DESCRIPTION OF THE DISCLOSURE

An object of the present disclosure is to provide a process and product which overcome the above problems related to the presently used methods for producing plant-based protein concentrates.

The object of the disclosure is achieved by a method and product which are characterized by what is stated in the independent claims. Some preferred embodiments of the disclosure are defined in the dependent claims.

The disclosure is based on the concept of concentrating the enzymatically treated plant protein by membrane filtration. A novel method is used to produce highly functional plant protein concentrates with improved techno-functional properties. Enzyme-aided slightly alkaline (pH 7.0-pH 9.0) extraction is combined with membrane filtration and optionally subsequent diafiltration for the concentration of the extracted plant proteins. Proteins are recovered from the rest of the plant raw material by enzymes, i.e. enzymatic treatment and extracted into an aqueous phase. The membrane filtration is carried out to concentrate the obtained protein but at the same time to separate the undesired ingredients from the retentate to the permeate.

The present inventors found that the extraction of proteins in their native state milder alkaline pH is shown to be more suitable approach than the extraction of proteins in high alkaline conditions. In addition, starch present in the raw material increases viscosity, if heat is applied during the extraction process. These components i.e., starch and carbohydrates can be hydrolyzed enzymatically using carbohydrate and starch degrading enzymes thus enhancing the extractability of proteins.

The extraction, adjustment of pH, or membrane filtration alone are not sufficient to obtain a high-quality plant protein concentrate with high yield. The combination of the enzyme-aided slightly alkaline treatment at a pH which maintains the proteins soluble, such as pH 7.0-pH 9.0 and the subsequent membrane filtration improves the yield of proteins remarkably.

Improved yield of proteins is one advantage of the present process. Another advantage of the present process is that a high-quality protein powder having high protein content (more than 30%) and high solubility is obtained.

According to an aspect of the present disclosure, there is thus provided a process for concentrating plant-based protein, wherein the process comprises the steps of
a. preparing a plant suspension by mixing plant raw material containing plant protein to an enzyme mixture comprising
   at least one enzyme selected from starch-hydrolyzing glycoside hydrolases,
   at least one enzyme selected from cell wall degrading enzymes, and
   at least one enzyme selected from protein-modifying enzymes, and water to obtain an aqueous plant protein suspension;
b. incubating said aqueous plant protein suspension at a pH which maintains the proteins soluble to obtain an enzymatically treated plant protein suspension;
c. separating the insoluble solids from the enzymatically treated plant protein suspension to obtain a plant protein slurry with increased soluble protein content in dry matter;
d. concentrating the plant protein slurry using membrane filtration to obtain a plant-based protein concentrate as a retentate;
e. optionally drying the plant-based protein concentrate to obtain a dried plant-based protein concentrate.

According to another aspect of the present disclosure, there is thus provided a plant-based protein concentrate, wherein the plant-based protein concentrate,
has a protein concentration greater than about 30 wt % protein/dry matter;
comprises enzymatically treated and filtrated protein having an isoelectric point (pI) of from pH 4 to pH 5;
comprises 2-10 wt % of starch based on the total weight of the dry matter of the plant-based protein concentrate;
has a protein solubility of at least 80% at pH of about pH 6.0 to about pH 7.0;
has a loss modulus (G″) lower than a storage modulus (G′) and tanδ between 0.2 and 0.4.

According to a further aspect of the present disclosure, there is provided the use of the plant-based protein concentrate in food products.

### ABBREVIATIONS

DD deamidation degree

DE-UF-OPC deamidated and ultrafiltered oat protein concentrate

PG protein-glutaminase

PS protein solubility

UF-OPC ultrafiltered oat protein concentrate

### BRIEF DESCRIPTION OF THE DRAWINGS

In the following the invention will described in more detail by means of preferred embodiments with reference to the accompanying drawings.

FIG. 1 illustrates one embodiment of the process for concentrating plant-based protein.

FIG. 2 illustrates deamidation degree (DD, %) and protein solubility (PS, %) as a function of incubation time in the pilot scale. The following incubation times are presented: 1 h (pH 6.5), 2h (1 h pH 6.5+1 h pH 8.0), 3 h (1 h pH 6.5+2 h pH 8.0), 4 h (1 h pH 6.5+3 h pH 8.0).

FIG. 3 illustrates SDS-PAGE profile of proteins in oat flour during the protein extraction process. Non-reduced and mercaptoethanol-reduced 10% of Bis-Tris gel with indications of the samples as a function of processing time starting from 0 to 4 h and a molecular weight marker (=standard). Lanes 1 and 6 represent the enzymatically treated initial sample (=0 h processing time), samples of lanes 2 and 7 are treated for 1 h (=1 h processing time), samples of lanes 3 and 8 are treated for 2 h (=2 h processing time), samples of lanes 4 and 9 (=3 h processing time) are treated for 3 h and samples of lanes 5 and 10 are treated for 4 h (=4 h processing time). A molecular weight marker (=standard) is on the left side of the gel.

FIG. 4 illustrates protein solubility (PS, %) of oat flour (starting material; Oat flour (%); the line marked with squares), deamidated and ultrafiltered oat protein concentrate (Deamidated OPC, DE-UF-OPC, the line marked with circles), and ultrafiltered oat protein concentrate (Ultrafiltered OPC, UF-OPC, the line marked with triangles) as a function of pH (2.0-10.0).

FIG. 5A illustrates storage modulus (G′) and loss modulus (G″) of deamidated and ultrafiltered oat protein concentrate (DE-UF-OPC) and ultrafiltered oat protein concentrate (UF-OPC) at 0.1% strain. Different letters (a, b, c) indicate significant differences (p<0.05) between the storage and loss modulus.

FIG. 5B illustrates storage modulus (G′) and loss modulus (G″) of deamidated and ultrafiltered oat protein concentrate (DE-UF-OPC) as a function of strain (%) and right-side y-axis tanδ as a function strain (%).

FIG. 5C illustrates storage modulus (G′) and loss modulus (G″) of ultrafiltered oat protein concentrate (UF-OPC) as a function of strain (%) and right-side y-axis tanδ as a function strain (%).

### DEFINITIONS

In the present description and claims, the following words and expressions have meanings as defined below:

“Plant-based” refers to originating from plants, which are suitable for manufacturing edible food products in food technology applications.

“Plant raw material” may originate from any plant suitable for manufacturing edible food products in food technology applications. In the present process suitable plant raw materials include for example cereals, such as oat or barley, legumes such as peas or broad pea, nuts, tuberous plants such as potato, and various seeds. Even if only one plant raw material is used as a starting material, for example oat, there may be traces of other plant material, for example cereals, such as wheat, barley and/or rye.

Plant raw material from a cereal may be in a form of flour, grain, meal, flakes and/or groats. Said raw material may be milled or wet-milled. The plant raw material when providing a suspension of plant-based raw material containing protein, is typically a meal or in powder form. Tuberous plants, such as potato, may be used as plant material. Potato flour, ground potato or potato juice may be used as a raw material.

Plant raw material from cereals, such as oat raw material may be in a form of oat flour, oat meal, oat grain, oat flakes/crushed oats/rolled oat, oat bran, oat groats, and/or hulled oat. Suitable flours are for example cereal flour, legume flour or potato flour.

Legume or cereal flour can typically be divided into fiber and starch fractions, for example by air classification. For example, wheat can be fractionated into endosperm flour and fiber fraction (wheat bran). Similar fractionation can be applied to oat and pea. The fiber fraction also typically contains more protein, as they are both on the main part of the grain and attached to each other. In the present invention, proteins attached to fibers are released into an aqueous solution by enzymatic treatment. Therefore, fiber fraction (bran) is a suitable starting material for the present process.

In an embodiment the plant flour is provided in powder form, preferably having a particle size in the range of 5 to 1000 μm, more preferably from 10 to 800 μm, more preferably from 10 to 650 μm, more preferably from 10 to 275 μm, most preferably from 10 to 100 μm. Flour preferably has a particle size with a D90 value of 648 μm, i.e. 90% of the particles are smaller than 648 μm. In one embodiment, 100% of the particles have a particle size below 800 μm. In one embodiment, 90% of the particles have a particle size below 648 μm and in one embodiment, 50% of the particles have a particle size below 65 μm. The appropriate particle size will ensure processability of the flour and the suspension formed in step a. of the process. The powder should preferably not form lumps, because that would cause problems in the production line and reduce the quality of the plant-based protein concentrate.

As an alternative to using the cereals, such as oat, in the form of flour, it is also possible to practice the present invention with other forms of oat, such as rolled oats, partially milled oats, and oatmeal. One oat flour possessing a low level of bran or hull material is fine oat flour. Fine oat flour is a fraction of the whole oat flour obtained from a sieving or air classification process. The typical compositional analysis of fine oat flour is similar to whole oat flour for moisture, protein, and fat. Fine oat flour also retains a substantial percentage of the soluble fiber that is present in whole oat flour. However, fine oat flour contains less bran or insoluble fiber and more starch than whole oat flour.

The terms “protein isolate” and “protein concentrate” differ in terms of protein quantity. These differences are caused by the processing methods. “Protein concentrate” powder consists of from 30 wt % to 80 wt % protein. The remaining of the concentrate powder contains carbohydrates and fats. If different processing steps are used to reduce the fat and carbohydrate content, a “protein isolate” containing 80% or more protein by weight can be produced. Thus, “protein concentrate contains 30 wt %-80 wt % of protein and “protein isolate” contains at least 80 wt % of protein. Overall, the processing steps used in the production of isolate result in higher protein content and lower fat and carbohydrate content. However, the types of amino acids found in both forms of whey are virtually identical since they are derived from the same proteins.

Permeate refers to the filtrate, i.e. the liquid passing through the membrane. Retentate refers to the concentrate, i.e. the retained liquid.

The term “membrane process” refers for example to microfiltration (MF), ultrafiltration (UF), nanofiltration (NF) or reverse osmosis (RO).

Reverse osmosis (RO) refers to concentration of solutions by removal of water. RO is applied for example if a protein-free fraction is to be recovered from the permeate, or if an aqueous fraction is to be recycled. Said recycled fraction may for example be used in diafiltration.

Nanofiltration (NF) refers to concentration of organic components by removal of part of monovalent ions like sodium and chlorine (partial demineralization).

Ultrafiltration (UF) refers to concentration of large and macromolecules, for example proteins.

Microfiltration (MF) refers to separation of macromolecules. For example, if the raw material contains a large amount of fat, MF may be used to separate fat from the raw material.

Diafiltration refers to a design to obtain better purification. Water is added to the feed during membrane filtration to wash out the low molecular feed components that will pass through the membranes, such as lactose and minerals. Washing means that water is added once or several times. Washing can be done as many times and as much as necessary to remove undesired components.

A “plant-based food product” may refer to fermented, acidified or non-acidic (neutral) food products, such as traditional dairy-based products like yoghurt, drinkable yoghurt, crème fraiche or sour cream, sour milk, quark, cream cheese (Philadelphia-type soft cheese), set-type yoghurt, smoothie, or pudding.

### DETAILED DESCRIPTION OF THE DISCLOSURE

In the present disclosure, it was surprisingly found that a plant-based protein concentrate can be obtained using a process of concentrating an enzymatically treated plant protein by membrane filtration. The obtained plant-based concentrate can be used as such or optionally the obtained protein concentrate can be dried.

The invention is based on the finding that the membrane filtration process can be used to concentrate protein and filter out undesirable components from the enzymatically treated plant protein. The present inventors found that the extraction of proteins in their native state milder alkaline pH is shown to be more suitable approach than the extraction in high alkaline conditions. Enzyme-aided extraction is combined with slightly alkaline pH (such as pH 7.0-pH 9.0), which maintains the proteins soluble, followed by membrane filtration and optional diafiltration for concentrating the extracted plant proteins. Proteins are recovered from the rest of the plant raw material by enzymes and extracted into the aqueous phase. At the same time starch and carbohydrates can be hydrolyzed enzymatically using carbohydrate and starch degrading enzymes thus enhancing the extractability of proteins.

The present inventors developed an extraction method to produce highly functional oat protein concentrates. Enzyme-aided slightly alkaline (pH 8.0) extraction is combined with filtration and optionally subsequent diafiltration for concentration of the extracted plant proteins. Furthermore, the selected functional properties such as heat-induced gelation and solubility of the plant protein concentrates were observed. Deamidated and membrane filtrated plant protein concentrated are produced. The solubility of both protein concentrates is significantly improved at neutral and slightly alkaline pH compared to the solubility of proteins extracted from the starting material. Additionally, both protein concentrates produced equally strong heat-induced gel-like structures at a protein concentration of at least 8 wt %/dry matter.

The membrane filtration is carried out to concentrate the obtained protein but at the same time to separate the undesired ingredients from the retentate to the permeate.

The enzymatic extraction, pH adjustment, or membrane filtration alone are not sufficient to result in high-quality plant protein concentrate with high yield. The combination of the enzymatic treatment with adjusting pH to pH 7.0-pH 9.0 and the subsequent membrane filtration improves the yield of proteins remarkably. Undesirable components, which are separated to the permeate in the membrane filtration include such as digested peptides, and salts that cause flavor and color. Membrane filtration improves the quality of the obtained end product. Enzymatic extraction, pH adjustment, or membrane filtration alone are not sufficient to result in high-quality plant protein concentrate with high yield. The combination of enzymatic treatment with pH adjustment pH to pH 7.0-pH 9.0 and the subsequent membrane filtration improves the yield of proteins remarkably.

In an embodiment by using protein-glutaminase (PG) the solubility of plant proteins is improved by enzymatically deamidating proteins. In addition, by adjusting pH plant proteins are made more soluble. Enzymatic deamidation of plant proteins with protein-glutaminase (PG) as a treatment can be used to increase the extraction yield when extracting proteins with alkaline extraction. The present inventors found that the enzymatic treatment, such as with PG can be utilized in protein extraction. Furthermore, the present inventors found that the combination of enzymes such as β-glucanase, α-amylase, and amyloglucosidase can be used to enhance the extractability of oat proteins in combination with slight alkaline extraction.

The adjustment of pH combined with protein-glutaminase treatment is an effective combination as regards the yield in plant protein extraction. Soluble plant protein can be concentrated by membrane filtration and thereby increasing the amount of protein in dry matter. The concentrated plant protein slurry of the invention can be dried into a plant protein powder (concentrate) when the powder is very soluble in water.

Using the process of the present disclosure gluten-free plant base is obtained by using a proteolytic enzyme, wherein the solubility is improved with protein-glutaminase. By combining pH adjustment with the use of protein-glutaminase, 10-30% more soluble protein is achieved compared to pH adjustment alone.

An aqueous plant protein suspension is prepared by mixing plant material to an enzyme mixture which comprises starch-hydrolyzing glycoside hydrolases or starch-degrading glycoside hydrolases, cell wall degrading enzymes, and protein modifying enzymes, and optionally proteolytic enzyme cleaving prolamins. Preferably α-amylase, β-glucanase, protein-glutaminase and proteolytic enzyme cleaving prolamins are used. Said aqueous plant protein suspension is incubated at a pH, which maintains the proteins soluble, such as from pH 7.0 to pH 9.0 to obtain an enzymatically treated plant protein suspension. Insoluble solids are separated from the suspension to obtain a plant protein slurry, which mainly contains proteins and other soluble components.

The present disclosure relates to a process for concentrating plant-based protein comprising the steps of
a. preparing a plant suspension by mixing plant raw material containing plant protein to an enzyme mixture comprising
   at least one enzyme selected from starch-hydrolyzing glycoside hydrolases,
   at least one enzyme selected from cell wall degrading enzymes, and
   at least one enzyme selected from protein-modifying enzymes, and water to obtain an aqueous plant protein suspension;
b. incubating said aqueous plant protein suspension at a pH which maintains the proteins soluble to obtain an enzymatically treated plant protein suspension;
c. separating the insoluble solids from the enzymatically treated plant protein suspension to obtain a plant protein slurry with increased soluble protein content in dry matter;
d. concentrating the plant protein slurry using membrane filtration to obtain a plant-based protein concentrate as a retentate;
e. optionally drying the plant-based protein concentrate to obtain a dried plant-based protein concentrate.

The above-mentioned steps a. to e. may be performed in succession.

The disclosure also relates to plant-based protein concentrate obtainable by the present process.

The disclosure also relates to a plant-based protein concentrate, characterized in that said plant-based protein concentrate
has a protein concentration greater than about 30 wt % protein/dry matter;
comprises enzymatically treated and filtrated protein having an isoelectric point (pI) of from pH 4 to pH 5;
comprises 2-10 wt % of starch based on the total weight of the dry matter of the plant-based protein concentrate;
has a protein solubility of at least 80% at pH of about pH 6.0 to about pH 7.0;
has a loss modulus (G″) lower than a storage modulus (G′) and tanδ between 0. 2and 0.4.

The disclosure also relates to a food product comprising the plant-based concentrate obtainable with the present process.

The disclosure also relates to the use of the plant-based protein concentrate in food products.

Starch-degrading enzymes and fiber-degrading enzymes in combination with a specific pH range from pH 7.0 to pH 9.0 and filtration provides a specific effect of the present invention. In an embodiment an enzyme mixture comprises at least one enzyme (i.e. one or more enzymes) selected from each of the following groups consisting of starch hydrolyzing glycoside hydrolases, cell wall degrading enzymes, protein-modifying enzymes, and optionally proteolytic enzymes cleaving prolamins.

The present process for concentrating plant-based protein comprises the following step:
a. preparing a plant suspension by mixing plant raw material containing plant protein to an enzyme mixture comprising
   at least one enzyme selected from starch-hydrolyzing glycoside hydrolases,
   at least one enzyme selected from cell wall degrading enzymes, and
   at least one enzyme selected from protein-modifying enzymes, and water to obtain an aqueous plant protein suspension.

Plant raw material may originate from any plant. In an embodiment the plant material is selected from the group consisting of cereals, legumes, and tuberous plants.

In a preferred embodiment the plant material is selected from cereals, for example oat, barley, rye, and/or wheat. In another embodiment the plant material is selected from legumes, for example pea, and/or broad pea. In another embodiment the plant material is selected from tuberous plants, for example potato. Even if only one plant raw material is used as a starting material, for example oat, there may be traces of other plant material, for example cereals, such as wheat, barley and/or rye.

Plant-based protein may be cereal protein, preferably plant-based protein is selected from the group consisting of oat protein, barley protein and any mixture thereof.

Oat or oats (Avena sativa L.) is a species of cereal having various benefits. Oat has higher protein content compared to the other cereals such as wheat, barley, and rye. The distribution of proteins in the layers of oat groats are as following: 12% protein in the starchy endosperm, 18-30% in the bran, and 29-38% in the germ. The majority (70-80%) of oat proteins are globulins. Oat globulin proteins are primarily situated in the starchy endosperm in the protein bodies and in the aleurone layer. The second most abundant protein group is prolamins (avenins), which account for 4-15% of the total protein. Other minor protein group in oats is the water-soluble albumins. Their proportions of the total protein vary depending on the oat source (cultivars), growth conditions, and extraction method.

Plant raw material may be in a form of flour, grain, meal, flakes and/or groats.

Step a. may be preceded by a step of providing plant raw material.

The plant raw material in step a., when providing a suspension of at least one plant-based raw material containing protein, is typically a meal or in powder form.

In an embodiment the plant flour is provided in powder form, preferably having a particle size in the range of 5 to 1000 μm, more preferably from 10 to 800 μm, more preferably from 10 to 650 μm, more preferably from 10 to 275 μm, most preferably from 10 to 100 μm.

Flour preferably has a particle size with a D90 value of 648 μm, i.e. 90% of the particles are smaller than 648 μm. In one embodiment, 100% of the particles have a particle size below 800 μm. In one embodiment, 90% of the particles have a particle size below 648 μm and in one embodiment, 50% of the particles have a particle size below 65 μm. The appropriate particle size will ensure processability of the flour and the suspension formed in step a. of the process. The powder should not form lumps, because that would cause problems in the production line and reduce the quality of the plant-based protein concentrate.

Particle size and particle size distribution may be determined with any conventionally used method or equipment suitable for such determination.

The process according to any one of the preceding claims, wherein the plant suspension in step a. contains 10-40 wt %, preferably 15-30 wt %, more preferably 15-25 wt %, most preferably 20 wt % plant flour of total weight. The plant suspension may contain 10, 11, 12, 13, 14, 15, 16, 17, 18, 19, 20, 21, 22, 23, 24, 25, 26, 27, 28, 29, 30, 31, 32, 33, 34, 35, 36, 37, 38, 39 or 40 wt % plant flour of total weight, or in the range defined by any two of these values.

The suspension in step a. typically comprises totally about 2 to 80 wt. %, preferably 10 to 30 wt. % protein.

The enzymes which are suitable in the present process are starch-hydrolyzing glycoside hydrolases, cell wall degrading enzymes, and protein-modifying enzymes, and optionally proteolytic enzyme cleaving prolamins.

Glycoside hydrolases, also called glycosidases or glycosyl hydrolases, catalyze the hydrolysis of glycosidic bonds of complex sugars. They degrade biomass such as cellulose, hemicellulose and starch. These enzymes include for example amylases, such as α-amylase, or glucosidase, or glucanase, such as β-glucanase, or xylanase, or lactase, or chitinase, or sucrase, or maltase, or neuraminidase, or invertase, or hyaluronidase, or lysozyme.

A starch-hydrolyzing glycoside hydrolase suitable for use in the process of the present disclosure may be any glycoside hydrolase that is known to hydrolyze starch. These enzymes include such as α-amylase, β-amylase, pullulanase, isoamylase or amyloglucosidase. Said enzymes can be used alone or in any combinations with each other. Starch hydrolyzing hydrolase and dosage of the enzyme can be selected from the enzymes and dosages suitable for each purpose, as known to a person skilled in the art.

In an embodiment the starch-hydrolyzing glycoside hydrolase may be is selected from the group consisting of amylases, in particular α-amylase and/or amyloglucosidase.

In an embodiment the starch-hydrolyzing glycoside hydrolase is α-amylase. There are several commercially available α-amylase enzyme preparations that are suitable for use in the process of the present disclosure. One suitable α-amylase is BAN480L (Novozymes, Netherlands). One suitable amyloglucosidase includes Amigase Mega L (DSM, Netherlands).

A cell wall degrading enzyme suitable for use in the process of the present disclosure may be any cell wall degrading enzyme that is known to degrade a cell wall. For example, a fiber degrading glycoside hydrolase suitable for use in the process of the present disclosure may be any glycoside hydrolase that is known to degrade fiber. A cell wall degrading enzyme and dosage of the enzyme can be selected from the enzymes and dosages suitable for each purpose, as known to a person skilled in the art.

In an embodiment the cell wall degrading enzyme is selected from the group consisting of β-glucanase, cellulase and/or xylanase. One suitable β-glucanase includes Filtrase NL Fast (DSM, Netherlands).

If the plant raw material comprises β-glucan, a β-glucan degrading enzyme may be used. If the raw material contains β-glucan (for example oat or barley), large β-glucan molecules can be broken down to smaller molecules by β-glucan degrading enzyme, such as β-glucanase, for example Filtrase.

A protein-modifying enzyme suitable for use in the process of the present disclosure may for example be a protein-deamidating enzyme. Other suitable protein-modifying enzymes may be proline specific proteases (exoproteases). A suitable protein-deamidating enzyme for use in the process of the present disclosure may be any protein-deamidating enzyme that is known to deamidate proteins. One suitable protein-glutaminase includes PG500 (Ajinomoto, Japan). A protein-modifying enzyme and dosage of the enzyme can be selected from the enzymes and dosages suitable for each purpose, as known to a person skilled in the art.

In an embodiment the protein modifying enzyme is selected from the group consisting of deamidases and/or transglutaminases (TGs), preferably deamidase is protein-glutaminase (PG).

In an embodiment a dosage of the protein-modifying enzyme is 4-20 U/g protein. The dosage of the protein-modifying enzyme may be 4, 5, 6, 7, 8, 9, 10, 11, 12, 13, 14, 15, 16, 17, 18, 19, or 20 U/g protein, or in the range defined by any two of these values. One suitable protein-glutaminase includes PG500 (Ajinomoto, Japan).

Protein-glutaminase (PG; purified from Chryseobacterium proteolyticum, EC 3.5.1.44) hydrolyzes the side chain amino groups of specific protein-bound amino acid residues to release ammonia. The reaction occurs on the glutamine and asparagine residues of proteins to make glutamic and aspartic acid, respectively. PG converts a protein glutamine residue to a glutamate residue. Protein-glutaminase can deamidate glutamine residues in proteins to glutamate residues, but not asparagine residues or free glutamines. Deamidation of proteins can improve their solubility, emulsifying activity, foaming activity, and other functional properties by increasing the number of negative charges and changing the overall structure. The solubility of plant protein is improved by removing an amide functional group in the side chain of the amino acids asparagine and glutamine using acid treatment or by enzymatic deamidation with protein-glutaminase enzyme. Because of its selectivity and mildness, enzymatic protein deamidation is a method to improve protein functionality.

In an embodiment the enzyme mixture further comprises one or more proteolytic enzymes cleaving prolamins. The proteolytic enzyme cleaving prolamins may be selected from the group consisting of proteases.

The proteolytic enzyme cleaving prolamins suitable for use in the process of the present disclosure may be any proteolytic enzyme that is known to cleave prolamins. These enzymes include protein proteases. One suitable proteolytic enzyme cleaving prolamins is Maxipro (DSM, Netherlands). A proteolytic enzyme and dosage of the enzyme can be selected from the enzymes and dosages suitable for each purpose, as known to a person skilled in the art.

Cereals such as rye, wheat and barley contain gluten, whereas oat is naturally gluten-free. However, there may be residues of rye, wheat and barley in mills and product lines. Protease can be used for degrading residual gluten into concentration of 5-20 mg/kg product (gluten-free).

Transglutaminase (TG) is an enzyme that catalyses the formation of isopeptide bonds between proteins. Protein-glutaminase (PG) and transglutaminase (TG) may be used at the same time. The use of both TG and PG results in better structure even in low protein concentrations.

The gist of the invention is a specific combination of matrix degrading enzymes.

In an embodiment the mixing in step a. is carried out from 30 minutes to 5 hours, preferably from 1 hour to 4 hours, more preferably from 1 hours to 2 hours, most preferably 1 hour. The mixing time may for example be 30 or 45 minutes, 1, 1.5, 2, 2.5, 3, 3.5, 4, 4.5, or 5 hours, or in the range defined by any two of these values.

In an embodiment the mixing in step a. is carried out at a temperature of between 20° C. and 70° C., preferably between 30° C. and 65° C., more preferably between 40° C. and 65° C., more preferably between 50° C. and 60° C., most preferably at 60° C. The temperature during the mixing step may for example be 20, 25, 30, 35, 40, 45, 50, 55, 60, 65 or 70° C., or in the range defined by any two of these values.

In an embodiment the mixing in step a. is carried out at a pH of about pH 6.0 to about pH 7.0, preferably at a pH of 6.5.

In the mixing step of plant material, enzymes, and water the desired pH level may be between about pH 5.0 and about pH 7.5, preferably between about pH 6.0 and about pH 7.0, such as about 6.0, 6.1, 6.2, 6.3, 6.4, 6.5, 6.6, 6.7, 6.8, 6.9, or 7.0 or in the range defined by any two of these values. The pH may be 5.0, 5.1, 5.2, 5.3, 5.4, 5.5, 5.6, 5.7, 5.8, 5.9, 6.0, 6.1, 6.2, 6.3, 6.4, 6.5, 6.6, 6.7, 6.8, 6.9, 7.0, 7.1, 7.2, 7.3, 7.4, or 7.5, or in the range defined by any two of these values. The pH may be between pH 5.0 and pH 7.5, preferably between pH 6.0 and pH 7.0. The pH may be between pH 6.1 and pH 6.4, or from about pH 6.1 to about pH 6.4. The pH may be between 6.0 and pH 6.5, or from about pH 6.0 to about pH 6.5. The pH may be between pH 6.5 and pH 7.0, or from about pH 6.5 to about pH 7.0. The pH may be between pH 6.6 and pH 7.0, or from about pH 6.6 to about pH 7.0. Preferably the pH is pH 6.5 or about pH 6.5.

The process also comprises the following step:

b. incubating said aqueous plant protein suspension at a pH which maintains the proteins soluble to obtain an enzymatically treated plant protein suspension.

In an embodiment the incubation in step b. is carried out from 30 minutes to 8 hours, preferably from 1 hour to 5 hours, more preferably from 2 hours to 4 hours, more preferably from 2 hours to 3 hours, more preferably from 2.5 hours to 3 hours, most preferably 3 hours. The incubation time may for example be 30 or 45 minutes, 1, 1.5, 2, 2.5, 3, 3.5, 4, 4.5, 5, 5.5, 6, 6.5, 7, 7.5, or 8 hours, or in the range defined by any two of these values.

In an embodiment the incubation in step b. is carried out at a temperature of between 20° C. and 70° C., preferably between 30° C. and 65° C., more preferably between 40° C. and 65° C., more preferably between 50° C. and 60° C., most preferably at 60° C. The temperature during the mixing step may for example be 20, 25, 30, 35, 40, 45, 50, 55, 60, 65 or 70° C., or in the range defined by any two of these values.

In an embodiment the incubation in step b. is carried out at a pH from about pH 7.0 to about pH 9.0, preferably at a pH from more than pH 7 to about pH 9, more preferably from about pH 8.0 to about pH 9.0, most preferably at a pH of about pH 8.0.

In the mixing step of plant material, enzymes and water the desired pH level may be between about pH 6.0 and about pH 9.0, preferably between about pH 7.0 and about pH 9.0, such as about 7.0, 7.1, 7.2, 7.3, 7.4, 7.5, 7.6, 7.7, 7.8, 7.9, 8.0, 8.1, 8.2, 8.3, 8.4, 8.5, 8.6, 8.7, 8.8, 8.9, 9.0 or in the range defined by any two of these values. The pH may be 6.0, 6.1, 6.2, 6.3, 6.4, 6.5, 6.6, 6.7, 6.8, 6.9, 7.0, 7.1, 7.2, 7.3, 7.4, 7.5, 7.6, 7.7, 7.8, 7.9, 8.0, 8.1, 8.2, 8.3, 8.4, 8.5, 8.6, 8.7, 8.8, 8.9, or 9.0 or in the range defined by any two of these values. The pH may be between pH 6.0 and pH 9.0, preferably between pH 7.0 and pH 9.0. The pH may be between pH 7.0 and pH 7.5, or from about pH 7.0 to about pH 7.5. The pH may be between 7.0 and pH 8.0 or from about pH 7.0 to about pH 8.0. The pH may be between pH 7.5 and pH 8.0, or from about pH 7.5 to about pH 8.0. The pH may be between 8.0 and pH 9.0 or from about pH 8.0 to about pH 9.0. Preferably the pH is pH 8.0 or about pH 8.0.

The process also comprises the following step:
b. separating the insoluble solids from the enzymatically treated plant protein suspension to obtain a plant protein slurry with increased soluble protein content in dry matter;

In an embodiment the plant protein slurry with increased soluble protein content in dry matter comprises at least 10 wt % protein/dry matter, preferably 14-18 wt % protein/dry matter, such as 14, 15, 16, 17, or 18 wt % protein/dry matter, or in the range defined by any two of these values.

The separation in step c. may be carried out by sieving or centrifugation, such as with a decanter centrifuge. Any known separation method suitable for the present purpose and known to a person skilled in the art may be used.

In an embodiment in step c. 80-100% of insoluble solids are separated from enzymatically treated plant suspension.

The process may further comprise after step c. a heat treatment step, wherein the heat treatment is selected from the group consisting of pasteurization, ultra-high temperature (UHT) treatment, and extended shelf life (ESL) processing.

Pasteurization may be carried out at a temperature of about 55° C. to about 80°, preferably about 65° to 75°, more preferably about 75° C., for about 30 seconds to 30 minutes, preferably from about 3 minutes to about 15 minutes, more preferably from about 3 minutes to about 10 minutes, most preferably for about 5 minutes. The pasteurization temperature may for example be in the range of about 55° C. to about 80°, such as 55, 56, 57, 58, 59, 60, 61, 62, 63, 64, 65, 66, 67, 68, 69, 70, 71, 72, 73, 74, 75, 76, 77, 78, 79 or 80°° C., or in the range defined by any two of these values. The pasteurization time may for example be from about 30 seconds to 30 minutes, such as 30, 40, or 50 seconds, 1, 2, 3, 4, 5, 6, 7, 8, 9, or 10 minutes, or in the range defined by any two of these values.

Typically, ultra-high temperature (UHT) treatment is carried out at a temperature of at least 135° C., such as at a temperature of from 135 to 160° C. Typically, extended shelf life (ESL) processing is carried out at a temperature of 135° C. for 0.5s, when using a direct treatment. Typically, extended shelf life (ESL) processing is carried out at a temperature of 127° C. for 1 s, when using an indirect treatment with plate heat exchanger which heats faster than tubular systems. The higher the heat treatment temperature, the shorter the treatment time is and vice versa the lower the heat treatment temperature, the longer the treatment time is.

Pasteurization may be carried out irrespective of other heat treatments, such as UHT and/or ESL treatment.

The process also comprises the following step:
d. concentrating the plant protein slurry using membrane filtration to obtain a plant-based protein concentrate as a retentate;

According to an embodiment, the plant protein slurry may be concentrated using a suitable membrane process, such as microfiltration (MF), ultrafiltration (UF), nanofiltration (NF) or reverse osmosis (RO). Said membrane process can be used to separate certain components from plant protein slurry and the membrane type can be chosen depending on the desired composition of the final product. For example, for high purity protein product, with low amount of small molecular weight impurities, e.g. salts of said protein slurry, an ultrafiltration membrane with molecular weight cut-off (MWCO) of 1 to 100 kDa, preferably 5 to 20 kDa, more preferably 10 kDa. For example, MWCO may be 1, 2, 3, 4, 5, 6, 7, 8, 9, 10, 11, 12, 13, 14, 15, 16, 17, 18, 19 or 20 kDa or a range defined by any two of these values is preferred. Or the membrane type having nominal pore size below 0.1 μm, more preferably below 0.01μm, would be preferred. 10 kDa corresponds approximately a pore size of 0.01 μm, 100 kDa corresponds approximately a pore size of 0.1 μm, 500 kDa corresponds approximately a pore size of 1 μm. Different membrane types, such as spiral wound, hollow fiber, flat sheet, etc. can be applied. Likewise, said membrane process can be operated in a way deemed suitable to reach the desired outcome, e.g. batchwise, semi-batchwise, continuously, etc.

In an embodiment the plant-based protein concentrate as the retentate comprises 50-52 wt % protein/dry matter, such as 50, 51 or 52 wt % protein/dry matter.

In an embodiment the plant protein slurry is concentrated using ultramembrane filtration.

In one preferred embodiment the protein slurry is concentrated with ultramembrane filtration using 10 kDa spiral-wound membrane and rinsed with diafiltration.

Diafiltration can be applied to further assist in separation of permeable compounds from concentrate produced in a membrane process of previous description. The concentrated retentate has a dry matter content of 5-30%, preferably at least 10-20%, more preferably at least 12-18%. The concentrated retentate has a protein content greater than about 30wt % in dry matter. Preferably, the concentrated retentate has a protein content 30 to 80 wt % protein in dry matter, most preferably 50-60%, such as 50, 51, 52, 53, 54, 55, 56, 57, 58, 59 or 60 wt % in dry matter, or in the range defined by any two of these values.

The process also comprises the following step:
e. optionally drying the plant-based protein concentrate to obtain a dried plant-based protein concentrate.

A protein-free process water may be used in the diafiltration step as the dia-water, the dia-water may be for example tap water. Also, a suitable effluent for use in the diafiltration step is for example a permeate from reverse osmosis. Also, a suitable effluent is recycled water from a process, which contains no substance to be rinsed.

In an embodiment a process for concentrating plant-based protein comprises the steps of

a. preparing a plant suspension by mixing plant raw material containing plant protein to an enzyme mixture comprising
at least one enzyme selected from starch-hydrolyzing glycoside hydrolases,
at least one enzyme selected from cell wall degrading enzymes, and
at least one enzyme selected from protein-modifying enzymes, and water to obtain an aqueous plant protein suspension;

b. incubating said aqueous plant protein suspension at a pH which maintains the proteins soluble to obtain an enzymatically treated plant protein suspension;

c. separating the insoluble solids from the enzymatically treated plant protein suspension to obtain a plant protein slurry with increased soluble protein content in dry matter;

d. concentrating the plant protein slurry using membrane filtration to obtain a plant-based protein concentrate as a retentate;

e. optionally drying the plant-based protein concentrate to obtain a dried plant-based protein concentrate.

In an embodiment a process for concentrating plant-based protein comprises the steps of

a. providing plant raw material;

b. preparing a plant suspension by mixing the plant raw material containing plant protein to an enzyme mixture comprising
at least one enzyme selected from starch-hydrolyzing glycoside hydrolases,
at least one enzyme selected from cell wall degrading enzymes, and
at least one enzyme selected from protein-modifying enzymes, and water to obtain an aqueous plant protein suspension;

c. incubating said aqueous plant protein suspension at a pH which maintains the proteins soluble to obtain an enzymatically treated plant protein suspension;

d. separating the insoluble solids from the enzymatically treated plant protein suspension to obtain a plant protein slurry with increased soluble protein content in dry matter;

e. concentrating the plant protein slurry using membrane filtration to obtain a plant-based protein concentrate as a retentate;

f. optionally drying the plant-based protein concentrate to obtain a dried plant-based protein concentrate.

In an embodiment a process for concentrating plant-based protein comprises the steps of

a. preparing a plant suspension by mixing at a pH from about pH 6.0 to about pH 7.0 plant raw material containing plant protein to an enzyme mixture comprising
at least one enzyme selected from starch-hydrolyzing glycoside hydrolases,
at least one enzyme selected from cell wall degrading enzymes, and
at least one enzyme selected from protein-modifying enzymes, and water to obtain an aqueous plant protein suspension;

b. incubating said aqueous plant protein suspension at a pH from about pH 7.0 to about pH 9.0, which maintains the proteins soluble to obtain an enzymatically treated plant protein suspension;

c. separating the insoluble solids from the enzymatically treated plant protein suspension to obtain a plant protein slurry with increased soluble protein content in dry matter;

d. concentrating the plant protein slurry using membrane filtration to obtain a plant-based protein concentrate as a retentate;

e. optionally drying the plant-based protein concentrate to obtain a dried plant-based protein concentrate.

In an embodiment a process for concentrating plant-based protein comprises the steps of

a. preparing a plant suspension by mixing at a pH from about pH 6.0 to about pH 7.0 plant raw material containing plant protein to an enzyme mixture comprising
at least one enzyme selected from starch-hydrolyzing glycoside hydrolases,
at least one enzyme selected from cell wall degrading enzymes, and
at least one enzyme selected from protein-modifying enzymes, and water to obtain an aqueous plant protein suspension, wherein the plant raw material is cereal;

b. incubating said aqueous plant protein suspension at a pH from about pH 7.0 to about pH 9.0, which maintains the proteins soluble to obtain an enzymatically treated plant protein suspension;

c. separating the insoluble solids from the enzymatically treated plant protein suspension to obtain a plant protein slurry with increased soluble protein content in dry matter;

d. concentrating the plant protein slurry using membrane filtration to obtain a plant-based protein concentrate as a retentate;

e. optionally drying the plant-based protein concentrate to obtain a dried plant-based protein concentrate.

In another embodiment a process for concentrating plant-based protein comprises the steps of

a. preparing a plant suspension by mixing plant raw material containing plant protein to an enzyme mixture comprising
at least one enzyme selected from starch-hydrolyzing glycoside hydrolases,
at least one enzyme selected from cell wall degrading enzymes, and
at least one enzyme selected from protein-modifying enzymes, and water to obtain an aqueous plant protein suspension;

b. incubating said aqueous plant protein suspension at a pH which maintains the proteins soluble to obtain an enzymatically treated plant protein suspension;

c. separating the insoluble solids from the enzymatically treated plant protein suspension to obtain a plant protein slurry with increased soluble protein content in dry matter;

d. subjecting the plant protein slurry to heat treatment;

e. concentrating the plant protein slurry using membrane filtration to obtain a plant-based protein concentrate as a retentate;

f. optionally drying the plant-based protein concentrate to obtain a dried plant-based protein concentrate.

Still in another embodiment the process for concentrating plant-based protein comprises the steps of

a. preparing a plant suspension by mixing plant raw material containing plant protein to an enzyme mixture comprising
at least one enzyme selected from starch-hydrolyzing glycoside hydrolases,
at least one enzyme selected from cell wall degrading enzymes, and
at least one enzyme selected from protein-modifying enzymes, and
at least one enzyme selected from proteolytic enzymes cleaving prolamins, and water to obtain an aqueous plant protein suspension;

b. incubating said aqueous plant protein suspension at a pH which maintains the proteins soluble to obtain an enzymatically treated plant protein suspension;

c. separating the insoluble solids from the enzymatically treated plant protein suspension to obtain a plant protein slurry with increased soluble protein content in dry matter;

d. concentrating the plant protein slurry using membrane filtration to obtain a plant-based protein concentrate as a retentate;

e. optionally drying the plant-based protein concentrate to obtain a dried plant-based protein concentrate.

Still in another embodiment the process for concentrating plant-based protein comprises the steps of

a. preparing a plant suspension by mixing plant raw material containing plant protein to an enzyme mixture comprising
at least one enzyme selected from starch-hydrolyzing glycoside hydrolases,
at least one enzyme selected from cell wall degrading enzymes, and
at least one enzyme selected from protein-modifying enzymes, and
at least one enzyme selected from proteolytic enzymes cleaving prolamins water to obtain an aqueous plant protein suspension;

b. incubating said aqueous plant protein suspension at a pH which maintains the proteins soluble to obtain an enzymatically treated plant protein suspension;

c. separating the insoluble solids from the enzymatically treated plant protein suspension to obtain a plant protein slurry with increased soluble protein content in dry matter;

d. concentrating the plant protein slurry using ultramembrane filtration to obtain a plant-based protein concentrate as a retentate;

e. optionally drying the plant-based protein concentrate to obtain a dried plant-based protein concentrate.

Still in another embodiment the process for concentrating plant-based protein comprises the steps of

a. preparing a plant suspension by mixing plant raw material containing plant protein to an enzyme mixture comprising
at least one enzyme selected from α-amylase and amyloglucosidase,
at least one enzyme selected from β-glucanase, cellulase and xylanase, and
at least one enzyme selected from deamidases and transglutaminases, and
at least one enzyme selected from proteases, and water to obtain an aqueous plant protein suspension;

b. incubating said aqueous plant protein suspension at a pH which maintains the proteins soluble to obtain an enzymatically treated plant protein suspension;

c. separating the insoluble solids from the enzymatically treated plant protein suspension to obtain a plant protein slurry with increased soluble protein content in dry matter;

d. concentrating the plant protein slurry using ultramembrane filtration to obtain a plant-based protein concentrate as a retentate;

e. optionally drying the plant-based protein concentrate to obtain a dried plant-based protein concentrate.

Still in another embodiment the process for concentrating plant-based protein comprises the steps of

a. preparing a plant suspension by mixing oat raw material containing plant protein to an enzyme mixture comprising
at least one enzyme selected from α-amylase and amyloglucosidase,
at least one enzyme selected from β-glucanase, and
at least one enzyme selected from deamidases and transglutaminases, and water to obtain an aqueous plant protein suspension;

b. incubating said aqueous plant protein suspension at a pH of from about pH 7.0 to about pH 9.0 to obtain an enzymatically treated plant protein suspension;

c. separating the insoluble solids from the enzymatically treated plant protein suspension to obtain a plant protein slurry with increased soluble protein content in dry matter;

d. concentrating the plant protein slurry using ultramembrane filtration to obtain a plant-based protein concentrate as a retentate;

e. optionally drying the plant-based protein concentrate to obtain a dried plant-based protein concentrate.

Still in another embodiment the process for concentrating plant-based protein comprises the steps of

a. preparing a plant suspension by mixing oat raw material containing plant protein to an enzyme mixture comprising
at least one enzyme selected from α-amylase and amyloglucosidase,
at least one enzyme selected from β-glucanase, and
at least one enzyme selected from deamidases and transglutaminases, and
at least one enzyme selected from proteases water to obtain an aqueous plant protein suspension;

b. incubating said aqueous plant protein suspension at a pH of from about pH 7.0 to about pH 9.0 to obtain an enzymatically treated plant protein suspension;

c. separating the insoluble solids from the enzymatically treated plant protein suspension to obtain a plant protein slurry with increased soluble protein content in dry matter;

d. concentrating the plant protein slurry using ultramembrane filtration to obtain a plant-based protein concentrate as a retentate;

e. optionally drying the plant-based protein concentrate to obtain a dried plant-based protein concentrate.

Still in another embodiment the process for concentrating plant-based protein comprises the steps of

a. preparing a plant suspension by mixing at a pH from about pH 6.0 to about pH 7.0 plant raw material containing plant protein to an enzyme mixture comprising
at least one enzyme selected from α-amylase and amyloglucosidase,
at least one enzyme selected from β-glucanase, and
at least one enzyme selected from protein-glutaminase, and
at least one enzyme selected from proteases water to obtain an aqueous plant protein suspension, wherein the plant raw material is cereal;

b. incubating said aqueous plant protein suspension at a pH of from about pH 7.0 to about pH 9.0 to obtain an enzymatically treated plant protein suspension;

c. separating the insoluble solids from the enzymatically treated plant protein suspension to obtain a plant protein slurry with increased soluble protein content in dry matter;

d. concentrating the plant protein slurry using ultramembrane filtration to obtain a plant-based protein concentrate as a retentate;

e. optionally drying the plant-based protein concentrate to obtain a dried plant-based protein concentrate.

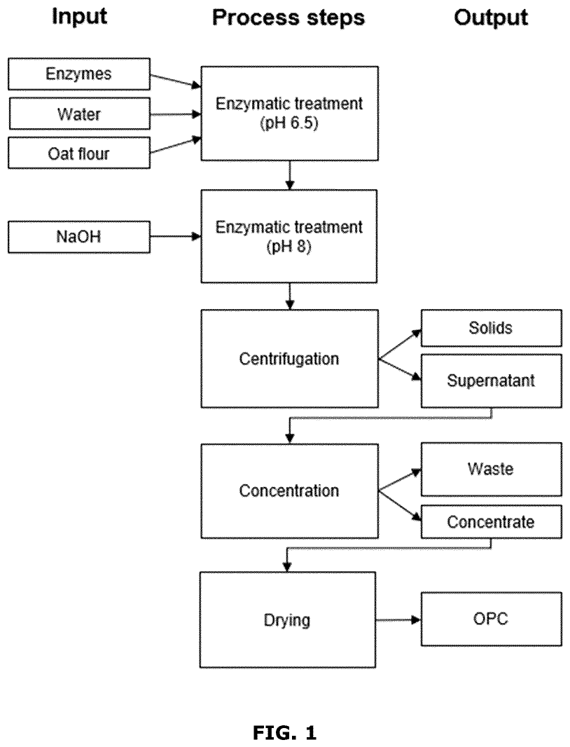

FIG. 1 presents one embodiment of the process for concentrating plant-based protein, wherein the process comprises the steps of mixing oat flour, enzymes and water and incubating at pH 6.5; adding NaOH and incubating said aqueous oat protein suspension at a pH 8 which maintains the proteins soluble to obtain an enzymatically treated oat protein suspension; separating the insoluble solids from the enzymatically treated oat protein suspension by centrifugation to obtain an oat protein slurry (supernatant) with increased soluble protein content in dry matter; concentrating the oat protein slurry (supernatant) to obtain an oat-based protein concentrate; drying the oat-based protein concentrate to obtain a dried oat protein concentrate (OPC).

The disclosure also describes a plant-based protein concentrate obtainable by the present process.

The disclosure also describes a plant-based protein concentrate, wherein said plant-based protein concentrate
has a protein concentration greater than about 30 wt % protein/dry matter;
comprises enzymatically treated and filtrated protein having an isoelectric point (pI) of from about pH 4 to about pH 5;
comprises 2-10 wt % of starch based on the total weight of the dry matter of the plant-based protein concentrate;
has a protein solubility of at least 80% at pH of about pH 6.0 to about pH 7.0;
has a loss modulus (G″) lower than a storage modulus (G′) and tanδ between 0.2 and 0.4.

The plant-based protein concentrate may be in a form of solution or powder.

In an embodiment the concentration of the plant-based protein concentrate may be greater than about 30 wt % protein/dry matter, such as greater than 40 wt %, 45 wt %, 50 wt %, 55 wt %, 60 wt %, 65 wt %, 70 wt %, or 75 wt % up to 80 wt %, or in the range defined by any two of these values. The concentration may be in the range of 30 wt %-80 wt %, preferably in the range of 50 wt %-60 wt %.

An isoelectric point (pI) of the plant-based protein concentrate may be from about pH 4 to about pH 5, such as pH 4.0, 4.1, 4.2, 4.3, 4.4, 4.5, 4.6, 4.7, 4.8, 4.9 or 5.0, or in the range defined by any two of these values.

The plant-based protein concentrate may comprise 2-10 wt % of starch based on the total weight of the dry matter of the plant-based protein concentrate, such as 2, 3, 4, 5, 6, 7, 8, 9 or 10 wt %, or in the range defined by any two of these values, or in the range of 4-6wt %. Any known method suitable for measuring the starch concentration and known to a person skilled in the art may be used.

The protein solubility may be at least 80%, such as at least 81, 82, 83, 84, 85, 86, 87, 88, 89, 90%, or in the range defined by any two of these values, at pH of about pH 6.0 to about pH 7.0, such as at pH of 6.0 to pH 7.0, or at pH of about 6.0, 6.1, 6.2, 6.3, 6.4, 6.5, 6.6, 6.7, 6.8, 6.9, or 7.0, or in the range defined by any two of these values. A suitable solubility measurement method known to a person skilled in the art may be used.

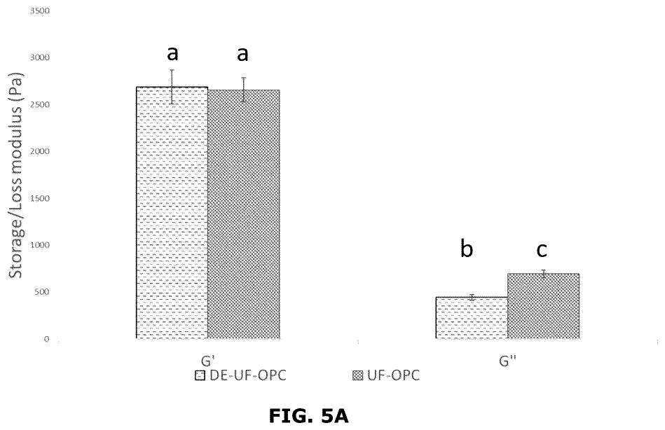

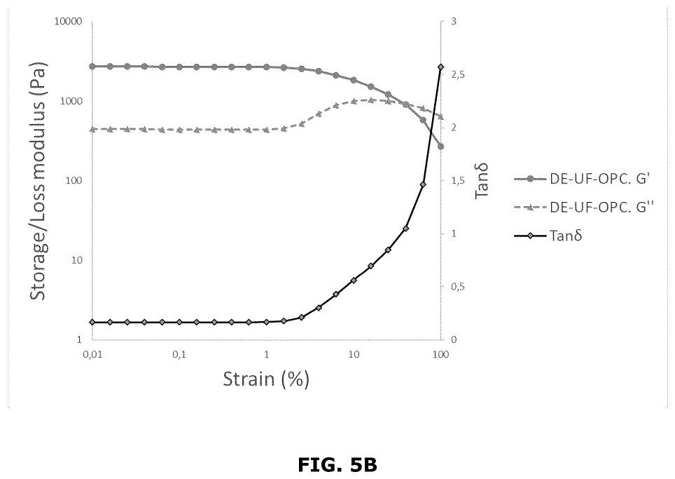

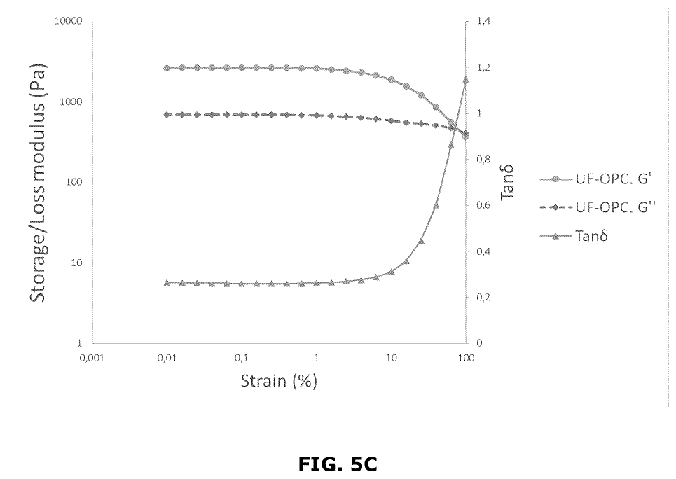

The plant-based protein concentrate may have a loss modulus (G″) lower than a storage modulus (G′) and tanδ between 0.2 and 0.4. In such conditions the plant-based protein concentrate has a property of forming a gelling structure. When the loss modulus (G″) is lower than a storage modulus (G′), the protein concentrate is rheologically a gel (FIGS. 5A, 5B and 5C).

When the protein content of the plant-based protein concentrate is high enough, spoonable gelling structures are formed. Surprisingly, the present plant-based concentrate forms heat-induced gel-like structures even in low protein concentrations, which is due to high quality of the protein. In order to be used in food product, the protein content of the plant-based protein concentrate is at least 8 wt %/dry matter, preferably 10-20 wt %/dry matter, such as 8, 9, 10, 11, 12, 13, 14, 15, 16, 17, 18, 19 or 20 wt %/dry matter, or in the range defined by any two of these values. Gelling occurs when the protein is denatured in high temperature (over 90° C.) and if the protein concentration is high enough, an elastic structure is formed.

In an embodiment the plant-based protein concentrate comprises 4-6 wt % of starch based on the total weight of the plant-based protein concentrate dry matter.

Preferably, the plant-based protein is from a cereal, more preferably from oat or barley.

The plant-based protein concentrate may be a protein isolate. The protein isolate may have a protein concentration of greater than 80 wt % protein/dry matter.

The plant-based protein concentrate may contain: 51-60 wt % protein, 21-23 wt % fat, 2-4 wt % ash, 2-4 wt % starch, and 2-10 wt % glucose.

The plant-based protein concentrate may contain: 51-60 wt % protein, such as 51, 52, 53, 54, 55, 56, 57, 58, 59 or 60 wt % protein; 21-23 wt % fat, such as 21, 22, 23 wt % fat; 2-4 wt % ash, such as 2, 3, or 4 wt % ash; 2-4 wt % starch, such as 2, 3, or 4 wt % starch, and 2-10 wt % glucose, such as 2, 3, 4, 5, 6, 7, 8, 9, or 10 wt % glucose. Said values may be in the range defined by any two of above-mentioned values.

The plant-based powder may contain maximum of 10 wt % water, preferably from 6 to 10 wt %, such as 6, 7, 8, 9, 10 wt %, or in the range defined by any two of these values.

In another embodiment deamidated and ultrafiltered protein concentrate was produced. Preferably said protein concentrate has greater than about 50 wt % protein/dry matter, such as about 52 wt % protein/dry matter, or greater than about 52 wt % protein/dry matter.

The solubility of both protein concentrates is significantly improved at neutral and slightly alkaline pH compared to the solubility of proteins extracted from the starting material. Additionally, both plant protein concentrates produce equally strong heat-induced gel-like structures at a protein concentration of at least 8 wt %/dry matter, preferably 10-20 wt %/dry matter, such as 8, 9, 10, 11, 12, 13, 14, 15, 16, 17, 18, 19 or 20 wt %/dry matter, or in the range defined by any two of these values, most preferably 10 wt %/dry matter.

The plant-based protein concentrate obtained with the process according to the present disclosure may be used in a food product selected from the group consisting of a drink, liquid plant base, dairy substitute, beverage, gurt, yoghurts, drinkable yoghurt, crème fraiche, sour cream, sour milk, pudding, set-type yoghurt, smoothie, quark, cheese, cream cheese, ice creams, and meat analogues.

In an embodiment a plant-based protein concentrate
has a protein concentration greater than about 30 wt % protein/dry matter;
comprises enzymatically treated and filtrated protein having an isoelectric point (pI) of from about pH 4 to about pH 5
comprises 2-10 wt % of starch based on the total weight of the dry matter of the plant-based protein concentrate;
has a protein solubility of at least 80% at pH of about pH 6.0 to about pH 7.0;
has a loss modulus (G″) lower than a storage modulus (G′) and tanδ between 0.2 and 0.4.

wherein the plant-based protein is from a cereal, preferably from oat.

It is apparent to a person skilled in the art that as technology advanced, the basic idea of the invention can be implemented in various ways. The invention and its embodiments are therefore not restricted to the above examples, but they may vary within the scope of the claims.

The present invention is further illustrated with the following examples.

### EXAMPLES

### Example 1

### Oat Protein Concentrate

### Materials and Methods

1. Materials

Organic oat flour was used. Alpha-amylase BAN480L (activity 480 KNU-b/g) was obtained from Novozymes (Rotterdam, Netherlands). Amyloglucosidase Amigase Mega L (activity 36 000 AGI/g) and β-glucanase Filtrase NL Fast (activity 40 000 BFG/g) were obtained from

DSM (Delft, Netherlands). Protein-glutaminase PG500 (activity 500 U/g) was obtained from Ajinomoto (Tokyo, Japan).
2. Deamidation degree and protein solubility

The deamidation degree (DD) was calculated according to the method of Yong. et al. 2004. DD was expressed as the ratio of ammonia produced by the deamidation by protein-glutaminase (PG) treatment to the ammonia produced in a total deamidation reaction (Equation 1), due to the stoichiometric relation between the amount of reacted amino acid residues and the ammonia produced.

$$DD [ \% ] = ( Ammonia after protease treatment [ g / L ] / Ammonia after total deamidation [ g / L ] ) \times 100 \qquad Equation 1$$

The centrifuged supernatant was treated with the protein precipitating agent, trichloroacetic acid (TCA) to stop the enzymatic reaction. The sample (250 μl) was pipetted into Eppendorf tubes together with 1 ml chilled (approximately 5° C.) 0.3 M TCA. The supernatant from the centrifuged oat-water suspension (without the PG treatment) was used as a control sample.

The released ammonia during total deamidation was evaluated by HCl treatment, a method presented by Jiang et al. 2015 with minor changes. Oat flour (400 mg) was suspended into 1.6 ml of 10% HCl and heated at 100° C. for 3 h with mixing by hand every 20 minutes. The hydrolyzed oat fluor samples were precipitated with TCA equivalently to the other samples. The samples were then centrifuged (Centrifuge 5424, Eppendorf, Germany) at room temperature at 12700×G for 5 min. The concentration of ammonia in the collected supernatants was measured using a commercial ammonia assay kit (Thermo Scientific, Vantaa, Finland).

The protein solubility of the supernatants (solubilized oat proteins from the oat flour suspensions) was determined by measuring the amount of nitrogen in the centrifuged supernatant. Nitrogen content was determined by the Kjeldahl method according to the method ISO 8968-1:2014. The protein content was calculated with the conversion factor, F, of 6.25. The protein solubility (%) was calculated by Equation 2. Each experiment was replicated three times. For the verification of this model additional experiment was done using the following parameters pH 8.0, incubation time of 3 h, and PG dosage of 12 U/g protein, and the extracted protein and deamidation degree were determined. The verification experiment values were then compared to the predicted protein solubility (%) and deamidation degree (%) values to determine the validity of the model.

$$Protein solubility [ \% ] = ( Nitrogen in the supernatant \times F / Nitrogen in the 40 g fluor sample \times F ) \times 100 \qquad Equation 2$$

3. The batchwise enzyme-aided extraction of oat proteins with optimized deamidation parameters in a pilot-scale

The oat protein extraction was done in a pilot-scale (total feed of 40 kg) with the optimized parameters. Two 20 kg oat-water suspension batches were prepared as follows: oat flour content of the suspension was 20% of total mass and the content of enzymes α-amylase, β-glucanase, amyloglucosidase, and protein-glutaminase were 0.1% of the total mass. Enzymes were added to water and mixed followed by the addition of the oat flour. The first incubation was done at pH 6.5 at 60° C. for 1 h in a water bath and a rotor mixer with an attached mixing blade was used to keep the oat-water suspension under constant mixing. After this, the pH was adjusted to pH 8.0 with 10% NaOH and the suspensions were further incubated for 3 hours at 60° C. The suspensions were centrifuged at 4000×G (Beckman Model J-6M Induction Drive Centrifuge, Beckman Instruments Inc, UK) for 10 min at 25° C. The supernatants were collected and heat-treated (75° C.; 5 min) in a water bath under constant mixing to inactivate the enzymes (protein-glutaminase, β-glucanase, and amyloglucosidase). The α-amylase remained active due to it being heat-stable at 75° C. After the heat treatment, the supernatants were placed overnight in a refrigerator to cooldown.

The supernatants, which contained the soluble protein and other soluble components were concentrated batchwise using a pilot-scale ultrafiltration plant with a 50 L feed vessel that was equipped with 2.5″ polymeric polyethersulfone spiral wound membrane element with a 10 kDa molecular weight cut-off and 2.044 m2 of surface area (Synder Filtration model ST3B, California, USA). Throughout the filtration process the conditions were kept constant; the temperature at 50° C., transmembrane pressure at 1.6 bar, and the pressure difference across the element at 0.8 bar. The concentration was continued until a volumetric concentration of 2.7 was reached, measured by constantly weighing the accumulated permeate.

In order to further reduce the content of sugars and other small-weight components in the concentrate (retentate), the concentrate was rinsed with water (i.e., diafiltered). The diafiltration was done by adjusting the feed volume of suspension to its initial volume with >40° C. tap water and re-concentrating the diluted feed until an equal amount of permeate was collected. The amount of diawater to the initial feed was in a ratio of 3.2:1.

The concentrated oat protein retentate was spray-dried (Buchi, mini spray dryer B-290, Flawil, Switzerland) at an inlet temperature of 165° C. and outlet temperature of 100° C. The dried oat protein concentrates (deamidated and ultrafiltered oat protein concentrate, DE-UF-OPC and ultrafiltered oat protein concentrate, UF-OPC) were stored in a double sealed plastic bag until used. Additionally, this extraction process was done to produce non-deamidated oat protein concentrate (UF-OPC). Furthermore, during the incubation phase of the pilot-scale process samples were collected to determine the deamidation degree (DD) and protein solubility (PS) as a function of incubation time (1-4 h) with methods presented in section 2 above.
4. Characteristics and functionality of oat protein concentrates
   4.1 Proximate composition of the raw material and oat protein concentrations

The protein content (total nitrogen×6.25) was determined by using the Kjeldahl method according to the method ISO 8968-1:2014. Ash, lipids, and moisture content were determined according to the methods ISO 8070:2007, ISO 1735:2004, and IDF26A: 1993, respectively.

The starch content of oat flour, DE-UF-OPC, and UF-OPC was analyzed with a commercial total starch assay kit (Amyloglucosidase/α-amylase method) from Megazyme (Bray, Ireland). The starch content was analyzed according to the manufacturer's instructions.

4.2 Characterization of proteins

The oat protein DE-UF-OPC, UF-OPC, and oat flour samples were characterized with sodium dodecyl sulfate polyacrylamide gel electrophoresis (SDS-PAGE) fractionation using 10% Bis-Tris gel (Criterion™ XT, BIO-RAD, Hercules, California, USA), with non-reduced and reduced samples. The used running buffer in the SDS-PAGE analysis was 10% 3-(N-morpholino) propane sulfonic acid (MOPS) and the reducing agent was mercaptoethanol. SeeBlue Plus 2 Pre-stained protein standard (Thermo Fischer Scientific, Invitrogen, CA, USA) was used as a molecular weight marker, and protein bands were stained with Coomassie Brilliant blue.

4.3 Protein solubility

The solubility of protein in DE-UF-OPC, UF-OPC, and oat flour (the starting raw material), as a function of pH (pH 2.0-10.0), was determined with a Bio-Rad DC protein assay (Bio-Rad, Hercules, California, USA). The preparation of samples was done according to the method by Rosa-Sibakov et al. 2018 with slight modifications. The samples were suspended (8% w/w) in deionized water at room temperature and mixed for 1 h under constant mixing with a magnetic stirrer. After this, the samples were then divided into smaller portions, and the pH was adjusted between pH 2.0-10.0 in 1.0 increments using 1 M HCl or 0.1 M NaOH. After pH adjustment, the samples were stirred for another hour. Finally, samples were centrifuged at 4000 x G for 15 min at 25° C. After centrifugation, the samples were diluted to fit the linear interval of the bovine serum albumin protein standard curve (0.2-1.5 mg/mL protein), and the Bio-Rad DC protein assay was done on the diluted samples according to the manufacturer's instructions. The samples were analyzed at 750 nm with a UV-Vis spectrophotometer (UV-1700 PharmaSpec, Shimadzu, Kyoto, Japan). Protein solubility is expressed as a percentage of the total amount of protein in the 8% w/w suspension. Each experiment was done in duplicate.

4.4 Preparation of heat-induced gels

The gels were prepared by dispersing DE-UF-OPC and UF-OPC powders in deionized water and stirred for 60 min under constant mixing with a magnetic stirrer at room temperature. The protein content of each suspension was set to 10% w/w. The pH of DE-UF-OPC suspension was 6.5 and the pH of UF-OPC suspension was adjusted from pH 7.0 to 6.5 using 2% HCl.

The suspension was placed in a cylindrical stainless-steel vessel (5.0 cm in height and 3.0 cm in width) that was coated with food-grade silicone oil. Nitrogen gas was used to remove air from the OPC suspensions before the vessel was sealed airtight. The vessel was immersed into an oil bath (MGW Lauda C6 CS, Baden-Württemberg, Germany) at 120° C. for 60 min. After the heat treatment, the vessel was placed into an ice bath for 5 minutes before being stored overnight at 6° C.

4.5 Rheological measurements

To determine the strength of heat-induced gels the gel containing vessels were taken out from the cold storage 1 h before the measurement. The oat protein concentrate (OPC) gels (4 cm in height) were gently removed from the vessels and cut to slices of 2 mm in height, using a cheese wire cutter. The gel slices were measured by amplitude sweep using Anton Paar Physica MCR301 rheometer (Anton Paar GmbH, Graz, Austria). The measurement was done using 25 mm plate and plate geometries with a 2 mm gap. The DE-UF-OPC and UF-OPC gels were measured using strain values from 0.01 to 100% and an angular frequency (w) of 10 rad/s. The reported result was taken from a strain value of 0.1%. Each measurement was replicated three times and contained in itself a triplicate measurement, resulting in a total of nine measurements per sample.

4.6 Statistical analysis

All results were expressed as an average of at least triplicate measurement, with error values according to the mean standard deviation, if not otherwise mentioned. MODDER) Pro software version 12.0 (MKS Instrument AK, MA, USA) was used to generate the prediction models and calculate regression coefficients of the models and create the surface and contour plots. One-way ANOVA was used for statistical analysis of gel strength of oat proteins, and this was followed by Tukey's honestly significant difference (HSD) with p<0.05. Statistical analysis was performed using Minitab Statistical Software v. 20.1.1 (Minitab, Inc., State College, PA, USA).

Results

The batchwise enzyme-aided extraction of oat proteins in a pilot-scale

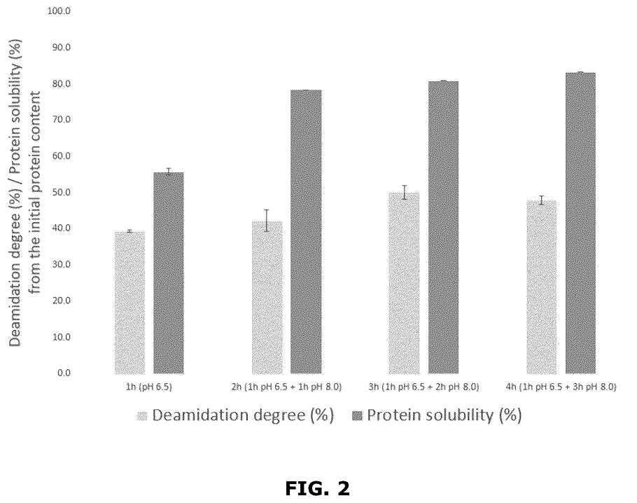

The deamidation degree (DD) and protein solubility (PS) were determined as a function of incubation time (FIG. 2). FIG. 2 illustrates deamidation degree (DD, %) and protein solubility (PS, %) as a function of incubation time in the pilot scale. The following incubation times are presented: 1 h (pH 6.5), 2h (1 h pH 6.5+1 h pH 8.0), 3 h (1 h pH 6.5+2 h pH 8.0), 4 h (1 h pH 6.5+3 h pH 8.0). Higher PS (around 80%) and DD (above 45%) were achieved due to the addition of protein-glutaminase (PG) enzyme at the start of process. The concentration of starch in the oat protein concentrates was decreased from 49.0% to approximately 2.5% by the enzymes that were utilized in the enzyme-aided extraction process (Table 1). Oat protein concentrates DE-UF-OPC and UF-OPC were successfully produced using the enzyme-aided extraction method with ultrafiltration concentration and subsequent diafiltration in a pilot-scale. As presented in Table 1, DE-UF-OPC (52.4%) had significantly higher (p<0.05) protein concentration than UF-OPC (45%) suggesting that deamidation improved the extractability of oat proteins. Oat protein concentrates that have been produced using higher alkaline pH (pH>9.0) typically have a protein concentration of 60 to 70%. However, the extracted protein yields with alkaline extraction (pH>9.0) can be as low as 10 to 15% of the total protein content. Oat protein concentrates produced in this work were extracted using lower pH values, which can decrease the protein content in the protein concentrates. The yield of the proteins can be increased with the assistance of enzymes.

TABLE 1
The composition of oat flour (starting material), ultrafiltered oat protein
concentrate (UF-OPC), and deamidated & ultrafiltered oat protein concentrate
(DE-UF-OPC). Different letters (a, b, c, d, e, f, g, h) indicate the
significant differences (p < 0.05) within the sample groups.

| | Protein | Fat | Ash | Starch | Glucose | Moisture |
|---|---|---|---|---|---|---|
| Sample | (%) | (%) | (%) | (%) | (%) | (%) |
| Oat flour | 12.8 ± 0.1^{a} | 8.2 ± 0.1^{d} | 1.8 ± 0.0^{g} | 49.0 ± 1.1 | — | 8.1 ± 0.0 |
| UF-OPC | 45.0 ± 0.1^{b} | 27.6 ± 0.1^{e} | 2.9 ± 0.0^{h} | 2.5 ± 0.0 | 4.0 ± 0.0 | 1.7 ± 0.0 |
| DE-UF-OPC | 52.4 ± 0.6^{c} | 22.3 ± 0.1^{f} | 3.0 ± 0.1^{h} | 2.4 ± 0.2 | 6.7 ± 0.1 | 2.0 ± 0.3 |

### Characterization of Oat Proteins

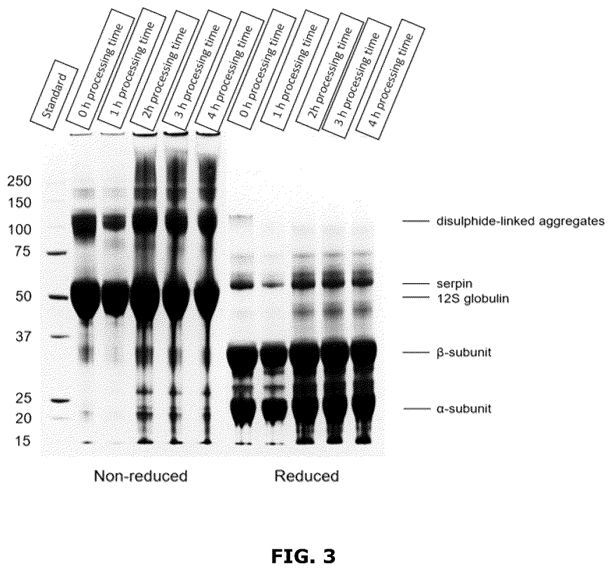

The SDS-PAGE was undertaken to determine whether the structure of oat proteins was changed during the extraction process (FIG. 3). FIG. 3 illustrates SDS-PAGE profile of proteins in oat flour during the protein extraction process. Non-reduced and mercaptoethanol-reduced 10% of Bis-Tris gel with indications of the samples as a function of processing time starting from 0 to 4 h and a molecular weight marker (standard). Lanes 1 and 6 represent the enzymatically treated initial sample (=0 h processing time), samples of lanes 2 and 7 are treated for 1 h (=1 h processing time), samples of lanes 3 and 8 are treated for 2 h (=2 h processing time), samples of lanes 4 and 9 (=3 h processing time) are treated for 3 h and samples of lanes 5 and 10 are treated for 4 h (=5 h processing time). Under reducing conditions, 30 kDa and 20 kDa bands were the most dominant in SDS-PAGE. The 50 kDa band is a native oat globulin protein that breaks into 30 kDa and 20 kDa subunits in reducing conditions.

### Solubility of the Oat Protein Concentrates as a Function of pH

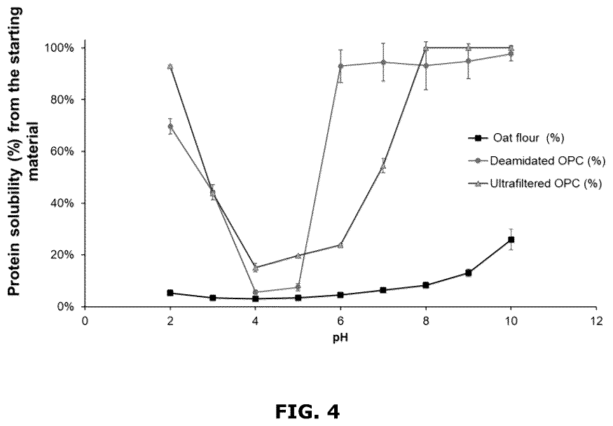

The protein solubility (PS) of oat flour (starting material; Oat flour (%); the line marked with squares), DE-UF-OPC (deamidated and ultrafiltered oat protein concentrate; Deamidated OPC (%); the line marked with circles), and UF-OPC (ultrafiltered oat protein concentrate; Ultrafiltered OPC (%); the line marked with triangles) as a function of pH (pH 2.0-10.0) is presented in FIG. 4. The PS of DE-UF-OPC was over 90% at pH 6.0, which is a remarkable improvement in protein functionality in comparison to that of oat flour. Additionally, UF-OPC had a good PS at pH 7.0, when pH was pH 8.0 and above, the solubility of the proteins increased to almost 100%. Surprisingly, UF-OPC had a higher protein solubility (above 90%) than DE-UF-OPC (about 70%) at acidic pH (pH 2.0).

Rheological properties of heat-induced oat protein concentrate gels

The gel strengths of DE-UF-OPC and UF-OPC were about 2700 and 2650 Pa, respectively at a constant protein concentration of 10% and amplitude strain of 0.1% (FIG. 5A). FIG. 5A illustrates storage modulus (G′) and loss modulus (G″) of deamidated and ultrafiltered oat protein concentrate (DE-UF-OPC) and ultrafiltered oat protein concentrate (UF-OPC) at 0.1% strain. Different letters (a, b, c) indicate significant differences (p<0.05) between the storage and loss modulus. There were not significant (p>0.05) differences between the storage moduli (G′) of oat protein concentrates DE-UF-OPC and UF-OPC, which indicates that the gels were equally as strong at 0.1% strain. To our knowledge, no similar gel strength measurements have been published using a similar protein extraction method.

The loss moduli (G″) of both gels were significantly different (p<0.05). The linear viscosity region (LVR) was noticeable longer in UF-OPC when compared to the DE-UF-OPC (FIG. 5B, FIG. 5C). FIG. 5B presents storage modulus (G′) and loss modulus (G″) of deamidated and ultrafiltered oat protein concentrate (DE-UF-OPC) as a function of strain (%) and right-side y-axis tanδ as a function strain (%). FIG. 5C presents storage modulus (G′) and loss modulus (G″) of ultrafiltered oat protein concentrate (UF-OPC) as a function of strain (%) and right-side y-axis tanδ as a function strain (%). Additionally, loss modulus (G″) of DE-UF-OPC increased at 4% strain before crossing the storage modulus (G″). This behavior was not noticed in the UF-OPC, there was only a decrease in the loss modulus at the yield point (64% strain) (FIG. 5C). This means when an external strain is applied the structure resists the deformation to a certain strain, this is the point where G″ increases. Additionally, when the deformation increases over the critical strain (yield point) the structure is fractured and G″ starts to decrease.

In the present example two different oat protein concentrates with a protein concentration of about 40 to 50% were successfully produced with an enzyme-aided slightly alkaline pH (pH 8.0) extraction method with ultrafiltration and subsequent diafiltration concentration in a pilot-scale. Additionally, the extractability of oat proteins was further enhanced by the enzymatical deamidation with PG. The DE-UF-OPC had significantly improved solubility in water at neutral pH where oat proteins typically remain insoluble. Surprisingly, the ultrafiltration process also improved the solubility of oat proteins at a slightly alkaline pH.

### Example 2

### Extraction of Proteins with and without Protein-glutaminase (PG)

Organic oat flour was used. Alpha-amylase BAN480L (activity 480 KNU-b/g) was obtained from Novozymes (Rotterdam, Netherlands). Amyloglucosidase Amigase Mega L (activity 36 000 AGI/g) and β-glucanase Filtrase NL Fast (activity 40 000 BFG/g) were obtained from DSM (Delft, Netherlands). Protein-glutaminase PG500 (activity 500 U/g) was obtained from Ajinomoto (Tokyo, Japan).

The following four extraction experiment were carried out:
1. 5% oat flour suspension was treated with 0.05% β-glucanase Filtrase at pH 9.0 for 3 hours at a temperature of 45° C.
2. 5% oat flour suspension was treated with 0.05% β-glucanase Filtrase and 2 U/g protein protein-glutaminase at pH 9.0 for 3 hours at a temperature of 45° C.
3. 23% fine oat flour suspension was treated with 0.5% β-glucanase Filtrase and 2 U/g protein protein-glutaminase at pH 9.0 for 3 hours at a temperature of 40° C.
4. 23% fine oat flour suspension was treated with 0.5% β-glucanase Filtrase and 2 U/g protein protein-glutaminase and 1.2 U/g protein transglutaminase at pH 7.0 for 3 hours at a temperature of 55° C.

Extracted protein concentration (%) and the amount of soluble protein from the starting material (%) are presented in Table 2.

TABLE 2
Enzymatic extraction of oat proteins using β-glucanase (Filtrase),
protein-glutaminase (TG) and transglutaminase (TG).

| | Extracted | The amount of |
|---|---|---|
| | protein | soluble protein |
| | concentration | from the starting |
| Sample | (%) | material (%) |
| 5% Oat flour, pH 9.0 | 0.33 | 49.1 |
| (3 h, 45° C.) + 0.05% Filtrase | | |
| 5% Oat flour, pH 9.0 | 0.52 | 77.9 |
| (3 h, 45° C.) + 0.05% Filtrase + | | |
| 2 U/g protein protein-glutaminase | | |
| 23% Fine oat flour + 0.5% | 2.2 | 60.2 |
| Filtrase + PG (2 U/g protein), | | |
| pH 9.0 (3 h, 40° C.) | | |
| 23% Fine oat flour + 0.5% | 1.7 | 46.3 |
| Filtrase + PG (2 U/g protein) + | | |
| TG (1.2 U/g protein), | | |
| pH 7.0 (3 h, 55° C.) | | |

### Example 3

### Manufacturing an Oat Protein Concentrate

Low fat whole grain oat flour produced with CO₂ extraction was used as a plant protein source in this example. The composition of the whole grain oat flour is shown in Table 3.

TABLE 3
The composition of the whole grain oat flour.

| Whole grain oat flour | % |
|---|---|
| Dry solids content | 94.33 |
| Protein | 12.9 |
| Carbohydrates | 66.2 |
| Fat | 3.22 |
| Fiber | 10 |
| Ash | 2 |

Amyloglucosidase Amigase Mega L (activity 36 000 AGI/g), α-amylase Mycolase, protease Maxipro PSP, and β-glucanase Filtrase NL Fast (activity 40 000 BFG/g) were obtained from DSM (Delft, Netherlands). Protein-glutaminase PG500 (activity 500 U/g) was obtained from Ajinomoto (Tokyo, Japan).

Enzymes and oat flour were mixed into water. pH of the mixture was adjusted with 5% sodium hydroxide solution.

23 kg of oat flour was mixed in 73.9 kg of water. The dosage of the enzyme preparations into the mixture was about 0.4-0.5 kg each. The composition of the mixture (total of 100 kg) prepared is shown in Table 4.

TABLE 4
The composition of the mixture comprising
oat flour and enzymes (total of 100 kg).

| Ingredient | % | kg |
|---|---|---|
| Oat | 23 | 23 |
| Water | 73.4 | 73.4 |
| 5% NaOH | 1.2 | 1.2 |
| Protein-glutaminase | 0.4 | 0.4 |
| Filtrase | 0.5 | 0.5 |
| Mycolase | 0.5 | 0.5 |
| Amigase Mega L | 0.5 | 0.5 |
| Maxipro PSP | 0.5 | 0.5 |
| | 100.0 | 100.0 |
| Protein | 3.0 | 3.0 |
| Carbohydrates | 15.2 | 15.2 |
| Fat | 0.7 | 0.7 |
| Fiber | 2.3 | 2.3 |
| Ash | 0.5 | 0.5 |

The mixture of oat flour and enzymes was first incubated for about 2 hours at 60° C. After the two hours incubation the pH was adjusted to 9 using 5% sodium hydroxide solution. Thereafter, the incubation continued 2 more hours at 60° C.

After the incubation, the process liquor contained undissolved solids which solids were separated from the liquor with decanter centrifugation. The mass of the process liquor that contained the dissolved part of the liquor was reduced to 59 kg in the centrifugation. The mass of the solids containing portion of the liquor was 41 kg and its composition is shown in Table 5. The dry matter of the mass of the centrifuged solids contain portion was 35.4% (w/w). 78.5% of the dry matter was undissolved fibers and starch.

TABLE 5
The composition of the solids containing portion of the process
liquor after decanter centrifugation. The mass of the solids
containing portion of the liquor was 41 kg. The dry solids
content was 35.4% (w/w) corresponding to 14.5 kg.

| Ingredient | % | Kg | %/dry solids |
|---|---|---|---|
| Protein | 4.25 | 1.7 | 12.0 |
| Carbohydrates/fiber | 27.8 | 11.4 | 78.5 |
| Fat | 1.76 | 0.7 | 5.0 |
| Ash | 1.6 | 0.7 | 4.5 |
| Dry solids | 35.4 | 14.5 | 100 |

The protein containing liquor (59 kg) received from the centrifugation step was subjected to concentration and dia-filtration in an ultrafiltration unit. The composition or the protein liquor before the filtration step is shown in Table 6.

TABLE 6
The composition of the protein containing liquor (plant protein
slurry) obtained from the centrifugation step. The mass
of the protein containing liquor was 59 kg. The dry solids
content was 16.4% (w/w) corresponding to 9.6 kg.

| Ingredient | Percentage (%) | Weight (kg) | %/dry solids |
|---|---|---|---|
| Protein | 2.6 | 1.5 | 16.0 |
| Carbohydrates/fiber | 3.6 | 2.1 | 22.0 |
| Glucose | 9.3 | 5.5 | 57.0 |
| Fat | 0.5 | 0.3 | 2.7 |
| Ash | 0.4 | 0.2 | 2.3 |
| Dry solids | 16.4 | 9.6 | 100.0 |

After three-fold (3×) dia-filtering step in the UF unit the mass of the retentate was 9.2 kg corresponding to 16% (w/w) of the feed of the process liquor into the UF step. The dry matter content of the retentate was 18.2% (w/w) which is 1.7 kg. The concentration factor of the protein was 6.4.

The amount of dia-water used in the UF step was 48.8 kg. 84% (w/w) of the original feed of the UF step entered in the permeate. The dry matter content of the permeate was 6.27% (w/w) corresponding to 6.1 kg. The composition of the permeate is shown in Table 7.

TABLE 7
The composition of the permeate (97 kg) after the
ultrafiltration step. The dry matter content of the
permeate was 6.24% (w/w) corresponding to 6.1 kg.

| Ingredient | Percentage (%) | Weight (kg) | %/dry solids |
|---|---|---|---|
| Protein | 0.6 | 0.6 | — |
| Carbohydrates/fiber | 1.6 | 1.6 | 25.7 |
| Glucose | 4.04 | 3.9 | 64.4 |
| Fat | — | — | — |
| Ash | — | — | — |
| Dry solids | 6.24 | 6.1 | |

The protein concentrate of the present invention was concentrated and spray dried from the retentate of the UF filtering. The composition of the retentate before further concentration is shown in Table 8.

TABLE 8
The effect of dia-filtering steps in
the glucose content of the permeate.

| Sample | Dry solids (%) | Glucose (%) | Glucose (%)/dry solids |
|---|---|---|---|
| Permeate | 16.9 | 12.6 | 74.6 |
| 1. diawater | 13.3 | 9.78 | 73.5 |
| 2. diawater | 9.05 | 6.24 | 69.0 |
| 3. diawater | 6.27 | 4.04 | 64.4 |

TABLE 9
The composition of the retentate after three-fold (3×) dia-filtering
step in the UF unit. The mass of the retentate was 9.2 kg corresponding
to 16% (w/w) of the feed of the process liquor into the UF step. The
dry matter content of the retentate was 18.2% (w/w) which is 1.7 kg.

| | Percentage | Weight | | Yield (%) from the |
|---|---|---|---|---|
| Ingredient | (%) | (kg) | %/dry solids | starting material |
| Protein | 9.4 | 0.9 | 51.5 | 30 |
| Carbohydrates/fiber | 2.7 | 0.2 | 14.9 | 1 |
| Glucose | 3.88 | 0.4 | 21.3 | — |
| Fat | 1.6 | 0.1 | 8.8 | 14 |
| Ash | 0.63 | 0.1 | 3.5 | 20 |
| Dry solids | 18.2 | 1.7 | | |

It was observed that deamidation improves the solubility of the proteins. Furthermore, by using three-fold diafiltering the amount of glucose remaining in the retentate could be reduced. Protein solubility presented in FIG. 4 can be applied in the present example, as well.

### Example 4

### Manufacturing an Oat Protein Concentrate

Whole grain oat flour was used as a plant protein source. Enzymes and oat flour were mixed into water. Amyloglucosidase Amigase Mega L (activity 36 000 AGI/g), protease Maxipro PSP, and β-glucanase Filtrase NL Fast (activity 40 000 BFG/g) were obtained from DSM (Delft, Netherlands). Protein-glutaminase PG500 (activity 500 U/g) and transglutaminase were obtained from Ajinomoto (Tokyo, Japan). pH of the mixture was adjusted with 5% sodium hydroxide solution. 1.46 kg of oat flour were mixed in 5.74 kg of water. The dosage of the enzyme preparations in the mixture was about 0.007-0.019 kg of each. The composition of the mixture prepared is shown in Table 10.

TABLE 10
The composition of the mixture of oat flour and enzymes.

| Ingredient | Percentage (%) | Weight (kg) |
|---|---|---|
| Oat | 20 | 1.46 |
| Water | 78.60 | 5.74 |
| 15% NaOH | 0.74 | 0.05 |
| SYC (PG + TG) | 0.263 | 0.019 |
| Filtrase | 0.1 | 0.007 |
| Ban480L | 0.1 | 0.007 |
| Amigase Mega L | 0.1 | 0.007 |
| Maxipro PSP | 0.1 | 0.007 |
| Total amount | 100 | 7.3 |
| Protein | 2.8 | 0.2 |
| Carbohydrates | 11 | 0.8 |
| Fat | 1.6 | 0.1 |
| Fiber | 2.2 | 0.2 |
| Ash | — | — |

The mixture of oat flour and enzymes was first incubated for about 2 hours at 60° C. After the two hours incubation the pH was adjusted to 9 using 5% sodium hydroxide solution. Thereafter, the incubation continued 2 more hours at 60° C.

After the incubation, the process liquor contained undissolved solids which solids were separated from the liquor with decanter centrifugation. The mass of the process liquor that contained the dissolved part of the liquor was reduced to 6.06 kg in the centrifugation. The mass of the solids containing portion of the liquor was 1.2 kg and its composition is shown in Table 11. The dry matter of the mass of the centrifuged solids contain portion was 29.6% (w/w). 61.3% of the dry matter was undissolved fibers and starch.

TABLE 11
The composition of the solids containing portion of the process
liquor after decanter centrifugation. The mass of the solids
containing portion of the liquor was 1.2 kg. The dry solids
content was 29.6% (w/w) corresponding to 0.3 kg.

| Ingredient | Percentage (%) | Weight (kg) | %/dry solids |
|---|---|---|---|
| Protein | 6.2 | 0.038 | 20.9 |
| Carbohydrates/fiber | 18.1 | 0.2 | 61.3 |
| Fat | 3.51 | 0.044 | 11.8 |
| Ash | 1.77 | 0.022 | 6.0 |
| Dry solids | 29.6 | 0.3 | 100.0 |

The protein containing liquor (6.06 kg) received from the centrifugation step was subjected to concentration in an ultrafiltration unit. The composition or the protein liquor before the filtration step is shown in Table 12.

TABLE 12
The composition of the protein containing liquor (plant protein
slurry) obtained from the centrifugation step. The mass of
the protein containing liquor was 6.06 kg. The dry solids
content was 19.1% (w/w) corresponding to 1.16 kg.

| Ingredient | Percentage (%) | Weight (kg) | %/dry solids |
|---|---|---|---|
| Protein | 2.8 | 0.17 | 14.4 |
| Carbohydrates/fiber | 4.3 | 0.26 | 22.6 |
| Glucose | 10.7 | 0.65 | 56.0 |
| Fat | 1.05 | 0.06 | 5.5 |
| Ash | 0.29 | 0.02 | 1.5 |
| Dry solids | 19.1 | 1.16 | 100.0 |

After the step in the UF unit the mass of the retentate was 2.0 kg. The dry matter content of the retentate was 14% (w/w) which is 0.28 kg. The dry matter content of the UF permeate was 3.92% (w/w). The total mass of the permeate was 17.9 kg and dry matter 0.70 kg. The permeate was 67.5% of the feed. The composition of the permeate is shown in Table 13.

TABLE 13
The composition of the permeate (17.9 kg, including the dia-filtration
water) after the ultrafiltration step. The dry matter content
of the permeate was 3.92% (w/w) corresponding to 0.7 kg.

| Ingredient | Percentage (%) | Weight (kg) | %/dry solids |
|---|---|---|---|
| Protein | <0.05 | 0.03 | — |
| Carbohydrates/fiber | 1.33 | 0.24 | 33.9 |
| Fat | <0.2 | — | — |
| Glucose | 2.59 | 0.5 | 66.1 |
| Ash | <0.15 | — | — |
| Dry solids | 3.92 | 0.7 | |

The composition of the protein concentrate of the present invention as received as an retentate from the UF filtering step is shown in Table 14.

TABLE 14
The composition of the protein concentrate as received as a
retentate from the ultrafiltration step. The mass of the retentate
was 2.0 kg. The dry matter content of the retentate was 14.1%
(w/w) which is 0.28 kg. The protein yield from the starting
material was 67.5%. The loss of protein was 17.2%.

| Ingredient | Percentage (%) | Weight (kg) | %/dry solids |
|---|---|---|---|
| Protein | 7.0 | 0.14 | 50.0 |
| Carbohydrates/fiber | 1.4 | 0.03 | 10.0 |
| Glucose | 2.2 | 0.04 | 15.5 |
| Fat | 3.1 | 0.06 | 21.9 |
| Ash | 0.4 | 0.007 | 2.6 |
| Dry solids | 14.1 | 2.8 | 100 |

### Example 5

### Manufacturing an Oat Protein Concentrate

Low fat whole grain oat flour produced with CO₂ extraction was used as a plant protein source. Enzymes and oat flour were mixed into water. Alpha-amylase BAN480L (activity 480 KNU-b/g) was obtained from Novozymes (Rotterdam, Netherlands). Amyloglucosidase Amigase Mega L (activity 36 000 AGI/g), protease Maxipro PSP, and β-glucanase Filtrase NL Fast (activity 40 000 BFG/g) were obtained from DSM (Delft, Netherlands). Protein-glutaminase PG500 (activity 500 U/g) was obtained from Ajinomoto (Tokyo, Japan).

pH of the mixture was adjusted with 15% sodium hydroxide solution. 2.4 kg of oat flour was mixed in 8.0 kg of water. The dosage of the enzyme preparations in the mixture was about 0.009-0.014 kg each. The composition of the mixture (total of 10.5 kg) prepared is shown in Table 15.

TABLE 15
The composition of mixture (total
of 10.5 kg) oat flour and enzymes.

| Ingredient | Percentage (%) | Weight (kg) |
|---|---|---|
| Oat | 23 | 2.4 |
| Water | 75.64 | 8.0 |
| 15% NaOH | 0.74 | 0.078 |
| Protein-glutaminase | 0.09 | 0.009 |
| (500 U/g)* | | |
| Filtrase | 0.13 | 0.014 |
| Ban480L | 0.13 | 0.014 |
| Amigase Mega L | 0.13 | 0.014 |
| Maxipro PSP | 0.13 | 0.014 |
| Total amount | 100 | 10.5 |
| Protein | 2.97 | 0.312 |
| Carbohydrates | 15.23 | 1.603 |
| Fat | 0.74 | 0.078 |
| Fiber | 2.3 | 0.242 |
| Ash | 0.46 | −0.048 |

*Protein-glutaminase was applied in two portions.

The mixture of oat flour and enzymes was first incubated for about 2 hours at 60° C. After the two hours incubation the pH was adjusted to 9 using 15% sodium hydroxide solution. Thereafter, the incubation continued 2 more hours at 60° C.

After the incubation, the process liquor contained undissolved solids which solids were separated from the liquor with decanter centrifugation. The mass of the process liquor that contained the dissolved part of the liquor was reduced to 8.66 kg in the centrifugation. The mass of the solids containing portion of the liquor was 1.9 kg and its composition is shown in Table 16. The dry matter of the mass of the centrifuged solids contain portion was 31.25% (w/w). 68.75% of the dry matter was undissolved fibers and starch.

TABLE 16
The composition of the solids containing portion of the process
liquor after decanter centrifugation. The mass of the solids
containing portion of the liquor was 1.9 kg. The dry solids
content was 31.2% (w/w) corresponding to 0.6 kg.

| Ingredient | Percentage (%) | Weight (kg) | %/dry solids |
|---|---|---|---|
| Protein | 5.4 | 0.1 | 17.4 |
| Carbohydrates/fiber | 22.3 | 0.4 | 71.5 |
| Fat | 1.52 | 0.03 | 4.9 |
| Ash | 1.95 | 0.04 | 6.2 |
| Dry solids | 31.2 | 0.6 | 100.0 |

The protein containing liquor (8.66 kg) received from the centrifugation step was subjected to concentration in an ultrafiltration unit. The composition or the protein liquor before the filtration step is shown in Table 17.

TABLE 17
The composition of the protein containing liquor (plant protein
slurry) obtained from the centrifugation step. The mass
of the protein containing liquor was 8.66 kg. The dry solids
content was 22.5% (w/w) corresponding to 1.9 kg.

| Ingredient | Percentage (%) | Weight (kg) | %/dry solids |
|---|---|---|---|
| Protein | 2.625 | 0.2 | 11.7 |
| Carbohydrates/fiber | 6.755 | 0.6 | 30.0 |
| Glucose | 12.1 | 1.0 | 53.8 |
| Fat | 0.61 | 0.1 | 2.7 |
| Ash | 0.41 | 0.0 | 1.8 |
| Dry solids | 22.5 | 1.9 | 100.0 |

After the step in the UF unit the mass of the retentate was 0.943 kg. The dry matter content of the retentate was 11.9% (w/w) which is 0.1 kg. The dry matter content of the UF permeate was 6.89% (w/w). The total mass of the permeate was 6.82 kg and dry matter 0.47 kg. The composition of the permeate is shown in Table 18.

TABLE 18
The composition of the permeate (6.82 kg, including the dia-filtration
water) after the ultrafiltration step. The dry matter content
of the permeate was 6.89% (w/w) corresponding to 0.47 kg.

| Ingredient | Percentage (%) | Weight (kg) | %/dry solids |
|---|---|---|---|
| Protein | <0.05 | — | — |
| Carbohydrates/fiber | 0.3 | 0.02 | 4.4 |
| Fat | <0.2 | — | — |
| Glucose | 4.64 | 0.32 | 67.3 |
| Ash | 1.95 | 0.13 | 28.6 |
| Dry solids | 6.89 | 0.47 | |

The composition of the protein concentrate of the present invention as received as an retentate from the UF filtering step is shown in Table 19.

TABLE 19
The composition of the protein concentrate as received as a retentate
from the ultrafiltration step. The mass of the retentate was 0.943
kg. The dry matter content of the retentate was 11.9% (w/w) which
is 0.1 kg. The protein yield from the starting material was 63.4%.
The protein yield from the starting material was 63.4%. The protein
yield from the soluble proteins was 87.1%.

| Ingredient | Percentage (%) | Weight (kg) | %/dry solids |
|---|---|---|---|
| Protein | 6.1 | 0.06 | 50.9 |
| Carbohydrates/fiber | 2.4 | 0.02 | 20.6 |
| Glucose | 1.38 | 0.01 | 11.6 |
| Fat | 1.62 | 0.02 | 13.6 |
| Ash | 0.39 | 0.004 | 3.3 |
| Dry solids | 11.9 | 0.1 | 100 |

### REFERENCES

EP1371734

Jiang Z, Sontag-Strohm T, Salovaara H, Sibakov J, Kanerva P, Loponen J. Oat Protein Solubility and Emulsion Properties Improved by Enzymatic Deamidation. J Cereal Sci. 2015, 64, 126-132.

Rosa-Sibakov N, Re M, Karsma A, Laitila A, Nordlund E. Phytic Acid Reduction by Bioprocessing as a Tool to Improve the In Vitro Digestibility of Faba Bean Protein. J. Agric. Food Chem. 2018, 66, 10394-10399.

Yong Y. H, Yamaguchi S, Gu Y. S, Mori T, Matsumura Y. Effects of Enzymatic Deamidation by Protein-Glutaminase on Structure and Functional Properties of α-Zein. J. Agric. Food Chem. 2004, 52, 7094-7100.

Yong Y, Kashirskikh E V, Garmashov S Y, Izgaryshev A V, Kriger O V, Evsyukova A O. Functional Sports Food Based on the Oat Grain Protein. Sci Evolution, 2017, 2 (1), 73-81.

1-30. (canceled)

31. A process for concentrating plant-based protein, wherein the process comprises the steps of
a. preparing a plant suspension by mixing plant raw material containing plant protein to an enzyme mixture comprising
at least one enzyme selected from starch-hydrolyzing glycoside hydrolases,
at least one enzyme selected from cell wall degrading enzymes, and
at least one enzyme selected from protein-modifying enzymes, and
water to obtain an aqueous plant protein suspension;
b. incubating said aqueous plant protein suspension at a pH which maintains the proteins soluble to obtain an enzymatically treated plant protein suspension;
c. separating the insoluble solids from the enzymatically treated plant protein suspension to obtain a plant protein slurry with increased soluble protein content in dry matter;
d. concentrating the plant protein slurry using membrane filtration to obtain a plant-based protein concentrate as a retentate; and
e. drying the plant-based protein concentrate to obtain a dried plant-based protein concentrate.

32. The process according to claim 31, wherein the plant-based protein is a cereal protein selected from the group consisting of oat protein, barley protein and any mixture thereof.

33. The process according to claim 31, wherein the plant raw material in step a. is in a form of flour.

34. The process according to claim 33, wherein the plant flour is provided in a powder form having a particle size in the range of 5 to 1000 μm.

35. The process according to claim 31, wherein the starch-hydrolyzing glycoside hydrolase is selected from the group consisting of amylases, in particular from α-amylase and/or amyloglucosidase.

36. The process according to claim 31, wherein the cell wall degrading enzyme is selected from the group consisting of β-glucanase, cellulase and/or xylanase.

37. The process according to claim 31, wherein the protein-modifying enzyme is selected from the group consisting of deamidases and/or transglutaminases (TG), and wherein the deamidase is protein-glutaminase (PG).

38. The process according to claim 31, wherein the enzyme mixture further comprises one or more proteolytic enzymes cleaving prolamines.

39. The process according to claim 31, wherein the proteolytic enzyme cleaving prolamines is selected from the group consisting of proteases.

40. The process according to claim 37, wherein a dosage of the protein-modifying enzyme is 4-20 U/g of protein.

41. The process according to claim 31, wherein the plant suspension in step a. contains 10-40 wt % plant flour of total weight.

42. The process according to claim 31, wherein the mixing in step a. is carried out from 30 minutes to 5 hours.

43. The process according to claim 31, wherein the mixing in step a. is carried out at a temperature of between 20° C. and 70° C.

44. The process according to claim 31, wherein the mixing in step a. is carried out at a pH from about pH 6.0 to about pH 7.0.

45. The process according to claim 31, wherein the incubation in step b. is carried out from 30 minutes to 8 hours.

46. The process according to claim 31, wherein the incubation in step b. is carried out at a temperature of between 20° C. and 70° C.

47. The process according to claim 31, wherein the incubation in step b. is carried out at a pH from about pH 7.0 to about pH 9.0.

48. The process according to claim 31, wherein the plant protein slurry with increased soluble protein content in dry matter comprises at least 10 wt % protein/dry matter.

49. The process according to claim 31, wherein the separation in step c. is carried out by sieving or centrifugation, such as with a decanter centrifuge.

50. The process according to claim 31, wherein in step c. 80-100% of insoluble solids are separated from enzymatically treated plant suspension.

51. The process according to claim 31, wherein the process further comprises after step c. a heat treatment step, wherein the heat treatment is selected from the group consisting of pasteurization, ultra-high temperature (UHT) treatment, and extended shelf life (ESL) processing.

52. The process according to claim 31, wherein the plant-based protein concentrate as the retentate comprises 50-52 wt % protein/dry matter.

53. The process according to claim 31, wherein the plant protein slurry is concentrated using ultramembrane filtration.

54. A plant-based protein concentrate obtainable with the process according to claim 31.

55. A plant-based protein concentrate, wherein said plant-based protein concentrate
has a protein concentration greater than about 30 wt % protein/dry matter;
comprises enzymatically treated and filtrated protein having an isoelectric point (pI) of from pH 4 to pH 5;
comprises 2-10 wt % of starch based on the total weight of the dry matter of the plant-based protein concentrate;
has a protein solubility of at least 80% at pH of about pH 6.0 to about pH 7.0;
has a loss modulus (G″) lower than a storage modulus (G′) and tanδ between 0.2 and 0.4.

56. The plant-based protein concentrate according to claim 55, wherein said plant-based protein is from a cereal, comprising at least one of oat or barley.

57. The plant-based protein concentrate according to claim 55, wherein said plant-based protein concentrate, comprises 51-60 wt % protein, 21-23 wt % fat, 2-4 wt % ash, 2-4 wt % starch and 2-10 wt % glucose.

58. The plant-based concentrate according to claim 55, wherein said plant-based protein concentrate is a protein isolate.

59. The plant-based concentrate according to claim 55, wherein said plant-based protein concentrate is in the form of a solution or powder.

60. Use of the plant-based protein concentrate obtained with the process according to claim 31, in a food product selected from the group consisting of a drink, liquid plant base, dairy substitute, beverage, gurt, yoghurts, drinkable yoghurt, crème fraiche, sour cream, sour milk, pudding, set-type yoghurt, smoothie, quark, cheese, cream cheese, ice creams, and meat analogues.
